(19) United States
(12) Patent Application Publication
(10) Pub. No.: US 2006/0109983 A1
(43) Pub. Date: May 25, 2006

(54) Signal masking and method thereof

(76) Inventors: Randall Keith Young, Port Matilda, PA (US); Rita Ann Young, Port Matilda, PA (US)

Correspondence Address: LAW OFFICES OF CHARLES W. BETHARDS, LLP, P.O. BOX 1622, COLLEYVILLE, TX, 76034, US

(21) Appl. No.: 11/058,745

(22) Filed: Feb. 15, 2005

Related U.S. Application Data
(60) Provisional application No. 60/629,819, filed on Nov. 19, 2004.

(51) Int. Cl. H04K 1/02

(52) U.S. Cl. 380/252

(57) ABSTRACT

A method and corresponding apparatus of adaptively masking signals in an efficient effective manner includes providing a signal; generating a masking signal that adaptively corresponds to the signal; and inserting the masking signal into a channel corresponding to the signal at a location proximate to the source of the signal to facilitate masking the signal in the channel. The method or apparatus may be utilized in conjunction with a communication device.

### RELATED APPLICATIONS

This application is related to and claims priority from U.S. Provisional Application Ser. No. 60/629,819 titled CONVERSATION MASKING DEVICE AND METHOD OF USE by Young, et al. filed on Nov. 19, 2004. The Provisional Application is commonly owned by the same inventive entity as the present application and is hereby incorporated herein in its entirety.

### FIELD OF THE INVENTION

This invention relates in general to signal masking apparatus and methods, and more specifically to adaptively masking signals, such as speech signals, to limit intelligibility of such signals for unintended audiences.

### BACKGROUND OF THE INVENTION

Conversations between two parties may unintentionally disclose information to unintended audiences, e.g. bystanders or eavesdroppers, since they may inadvertently or intentionally overhear the conversation. This can be undesirable when confidential subject matter is being discussed. In some fields, statutes or ethical considerations mandate conversation privacy. Conversations, particularly in public locations, furthermore can be annoying to other parties, i.e., most people can attest to being annoyed or disturbed by someone on a cell phone call in a public location.

These problems can be avoided by foregoing conversations where bystanders may overhear inappropriate discussions or may be annoyed by otherwise appropriate conversations, however that may not be practical. Use of an earpiece or headset will make it difficult for bystanders or even intentional eavesdroppers to overhear incoming conversation on a cell phone, for example, but does nothing about the other side of the conversation. Foregoing sensitive conversations until the parties are in a secure location with access to a secure communication medium while often effective, again may not be practical or at least can be a significant burden on productivity.

Masking systems exist that attempt to blanket a given area or volume, e.g. office area, with a typically noise like masking signal emanating from a network of speakers at a sufficient volume. These systems mask local conversations between two or more parties or between a local party on a communication device and an external party, however these systems tend to be expensive, difficult to deploy/setup, can be annoying and disruptive and particularly so if improperly installed or maintained, and may not be effective against intentional eavesdroppers using bugging devices, high gain directional microphones and the like. Some systems attempt to adapt to the given space and may provide differing levels of the masking signal to different portions of the space. Such systems of course are completely ineffective beyond the given area or space. Some systems sense audible signals in one area and generate a masking signal that blankets another area, thereby attempting to eliminate annoyance to parties in the other area resulting from audible signals emanating from the originating area. This approach suffers from many of the shortcomings noted above.

Clearly existing approaches for providing masking signals do not provide satisfactory solutions to the above noted, among many other, problems.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages in accordance with various embodiments.

FIG. 1 depicts, in a simplified and representative form, a diagram depicting a signal unintentionally traversing a channel and a corresponding masking transmission or signal inserted in the channel in accordance with one or more embodiments.

FIG. 2 depicts, in a simplified and representative form, another diagram showing a signal unintentionally traversing a channel;

FIG. 3 depicts, in a simplified and representative form, a diagram similar to FIG. 2 showing a masking transmission being inserted into the channel with a signal in accordance with one or more embodiments;

FIG. 4 illustrates in a simplified and representative form, a block diagram of an apparatus for masking speech signals according to various embodiments;

FIG. 5 depicts an exemplary flow chart for a method embodiment of adaptively masking signals;

FIG. 6 depicts an exemplary and more detailed flow chart of a method embodiment of adaptively masking a signal.

FIG. 7 and FIG. 8 depict exemplary processes for generating a masking signal;

FIG. 9 shows in a simplified form alternative techniques for use in generating a masking signal;

FIG. 10 shows an exemplary masking signal that adaptively corresponds to a speech signal;

FIG. 11 shows another exemplary masking signal that adaptively corresponds to a another speech signal

FIG. 12 and FIG. 13 depict, respectively, a spectrogram of the speech signal and the masking signal of FIG. 11;

FIG. 14 and FIG. 15 depict, respectively, a spectrogram of the speech signal and the masking signal of FIG. 11 with a different scale for the horizontal axis;

FIG. 16 depicts a flow chart of a method embodiment of providing a masking signal for transmission to mask a voice signal according to various exemplary embodiments;

FIG. 17 depicts a simplified physical embodiment suitable for practicing one or methods in accordance with various exemplary embodiments;

FIG. 18 depicts a listing of Pseudo-code that may be utilized by the FIG. 17 embodiment to implement the method of FIG. 16;

FIG. 19 depicts another simplified block diagram suitable for practicing one or methods in accordance with various exemplary embodiments;

FIG. 20 shows a representative diagram of an input circular buffer arrangement for providing a masking signal in accordance with FIG. 19;

FIG. 21 shows a representative diagram of an output circular buffer arrangement for providing a masking signal in accordance with FIG. 19;

FIG. 22 depicts a flow diagram and corresponding structure for a method of providing a masking signal in accordance with various embodiments;

FIG. 23 illustrates an exemplary embodiment of a masking unit that may be associated with a communication device; and

FIG. 24 depicts a block diagram of an exemplary communication device including an integrated voice masking function.

FIG. 25 depicts an exemplary embodiment of a masking unit with a headset.

### DETAILED DESCRIPTION

In overview, the present disclosure concerns signal masking apparatus and methods and more particularly adaptively masking or covering signals to thereby limit intelligibility of such signals for unintended audiences. Generally a masking signal that adaptively corresponds to a signal to be masked or covered is generated and inserted into a channel or path together with the signal to be masked proximate to a location where the signal to be masked originates. Advantageously, the combination of the masking signal and the signal to be masked will have limited intelligibility for a recipient, when the concepts and principles disclosed and discussed below are practiced.

For example, when an individual speaks or generates an audible signal, such as speech, the audible signal can normally be overheard by bystanders. By generating an appropriate masking signal and broadcasting the masking signal via a speaker where the speaker is located proximate to the individual's mouth, the audible signal can be rendered unintelligible and thus the individual is afforded privacy for their conversation. The concepts and principles disclosed and described are applicable for conversations between two parties as well as conversations or communications via a communication device.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles may be implemented with or in software programs or instructions and corresponding processors or in hardware, such as integrated circuits (ICs), application specific ICs, or the like. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the various embodiments.

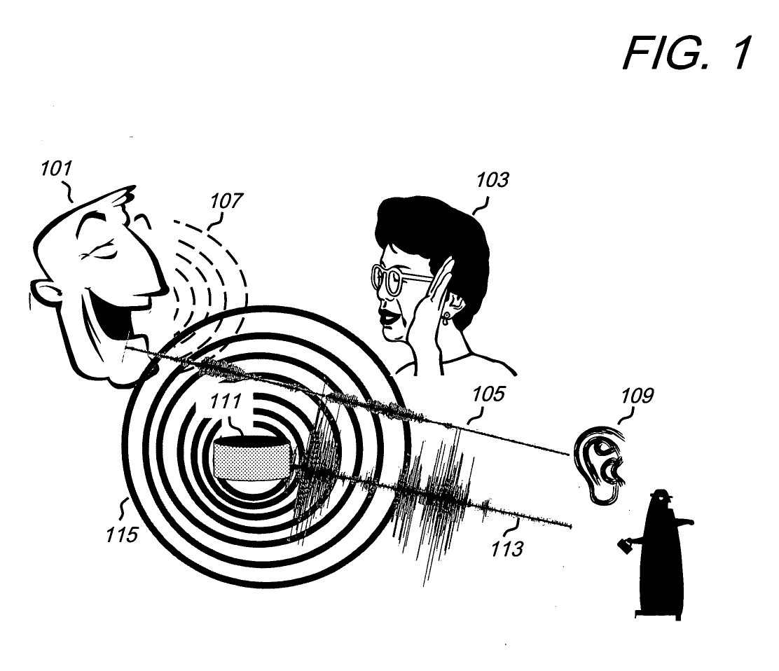

Referring to FIG. 1, a simplified and representative diagram depicting a signal unintentionally traversing a channel and a corresponding masking signal inserted in the channel in accordance with one or more embodiments will be discussed and described. FIG. 1 shows one situation, e.g., a conversation between two people, where a signal may be unintentionally overheard by another. When a person 101 speaks to another person 103 the speech signal 105, i.e., resultant acoustical field 107, will normally be heard by the other person 103 or listener but may be overheard or intercepted by unintentional and/or intentional listeners/listening devices/eavesdroppers (eavesdroppers) 109. For example, think of two people at a table having a conversation, with other people or eavesdroppers at surrounding tables or in the general vicinity, but removed from the people having the conversation. Note that the people 101, 103 may want to insure that eavesdroppers 109 cannot overhear or understand their conversation.

The apparatus 111 is arranged and located between, e.g. on the table and thus proximate to, the people 101, 103, and operates to provide conversation privacy or voice masking for the local conversation by transmitting a masking signal 113 or corresponding acoustical field 115 that corresponds to the speech signal in terms, for example, of energy as a function of time or the like. Generally, the apparatus operates by providing a signal that corresponds to the speech signal (output of a microphone) to a masking generator. The masking generator generates (described in detail below) the masking signal that adaptively corresponds to the signal and thus speech signal. The apparatus then inserts the masking signal 113 into a channel (path from person speaking 101 to an eavesdropper 109) corresponding to the signal (speech signal 105) at a location proximate to the source of the signal (near person speaking) to facilitate masking the signal in the channel to the relatively remote eavesdropper 109. Note that the masking generator generates a masking signal and this is applied or inserted into the channel as a masking transmission that corresponds to the masking signal. In these discussions masking transmission and masking signal may be used interchangeably; however it is understood that masking transmission implies the results of inserting the masking signal into the channel while the masking signal is the cause of those results. In one embodiment, the masking signal is applied to a transducer or speaker that transmits or broadcasts the masking transmission or signal 113 or corresponding acoustical field 115.

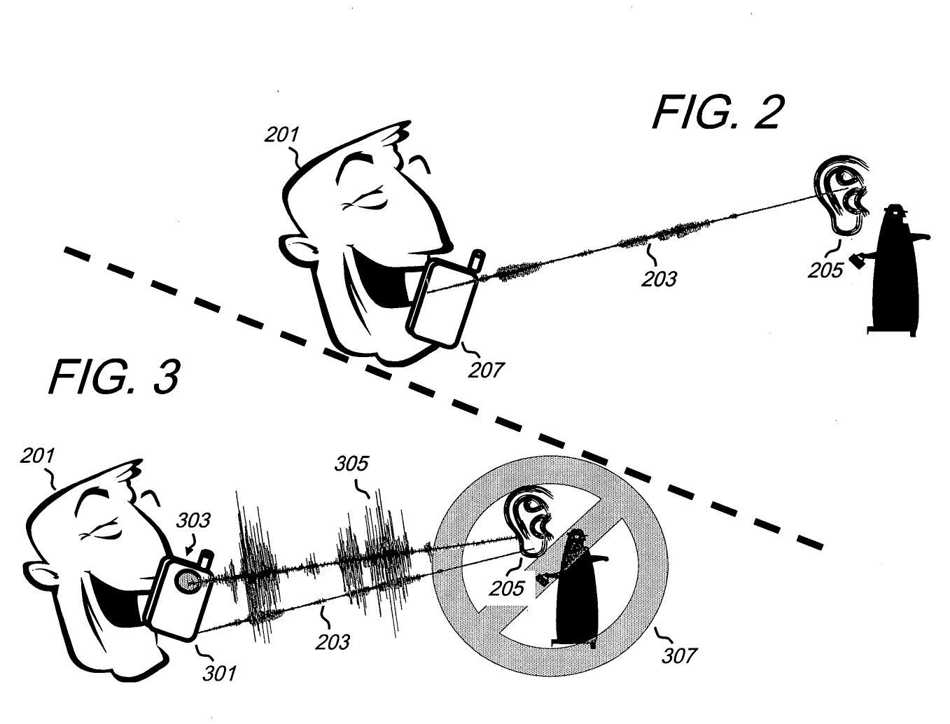

Referring to FIG. 2, another simplified and representative diagram showing a situation with a signal unintentionally traversing a channel will be discussed and described. As displayed in FIG. 2, a person 201 is speaking (speech signal 203) and this speech signal is traversing a channel and may be overheard by an eavesdropper 205 within hearing range. Note that the hearing range of an eavesdropper can be extended through amplification, filtering and acoustic antennas or the like. In this instance, the person is speaking on a communications device 207 to a remote person or device. The communication device may be some form of a wireless communication device, e.g. extension phone, walkie-talkie, two way radio, military radio, cellular handset, headset, or the like or a conventional telephone, packet data telephone, headset, or the like. In the situations shown by FIG. 1 and by FIG. 2 a signal, namely speech signal, is being applied to or traversing a desired channel, i.e., from the person speaking to the person or party listening (local or remote) as well as one or more undesired channels, i.e. from the person speaking to one or more eavesdroppers.

FIG. 3 depicts, in a simplified and representative form, a diagram of a situation similar to FIG. 2, where a masking signal is being inserted into the channel (channel from the person speaking 201 to the eavesdropper 205) in accordance with one or more embodiments. In this instance a communication device 301 includes, as a supplemental unit or fully integrated function, an apparatus 303 operating to generate and apply or insert a masking signal 305 into the channel or path, from the person speaking to one or more eavesdroppers 205, at a location proximate to the source of the signal (speaking person's mouth). In various embodiments the signal or speech masking processing is performed within the communications device 301 and a speaker 303 (part of apparatus 301) is embedded with the communications device and transmits the voice masking signal. By virtue of the masking signal 305 combined with the signal or speech signal the speech signal will be rendered unintelligible (depicted by symbol 307) at the location of the eavesdropper 205. Note that the apparatus 303 can be functionally similar to the apparatus 111 of FIG. 1.

Thus, FIG. 1 and FIG. 3 show examples of providing conversation privacy/voice masking for the persons 101, 103, 201 relative to any eavesdroppers 109, 205. The voice privacy is provided by deploying a speech-sensitive, voice-masking sound source embodied in apparatus 111, 301. The masking signal 113 created by the apparatus is inseparably projected, along with the speech, to any listeners/listening devices/eavesdroppers. By properly generating the masking signal, and possibly enabling volume adjustment of the masking signal, the sound impinging upon any eavesdroppers will be dominated by the voice masking signal and the speech signal will be rendered unintelligible to the eavesdroppers. This is insured by applying or inserting the masking signal in close vicinity or close proximity to the source of the signal, e.g. to a person's mouth, such that all paths and any impact on the speech signal and the masking signal from the paths are nearly identical. One embodiment creates the volume-controllable, virtual megaphone, voice masking device by embedding this system/method integrally into the person's portable communications device, i.e., in FIG. 3 the voice masking device and the communications device are the same unit. Note that in either apparatus 111, 301 a user may want a control to enable/disable masking signal generation, similar for example to a mute control for controlling what a remote listener is allowed to hear.

It will be useful to consider some desirable Sound or Noise Masking characteristics or features prior to a more detailed discussion of the masking signal generation and corresponding methods and apparatus. For example it may be desirable to protect/secure local conversations between individuals at the same location as well as between multiple parties at separate locations, that are using a communications device and provide mobile conversation security; i.e., enable users to mask their conversation wherever they are or wherever they are going. Any apparatus or method should be relatively low-cost to implement and easy to use/control/switch on-off/maintain (easy switching on/off and “dial-up” security assurance for each local user so that the person can trivially mask only the portion of their conversation that requires masking or security coverage; when conversation privacy is not required, it should be instantly and easily turned off for that user, but not necessarily for all users).

Any apparatus or method should offer high quality of service for the intended remote listener; thus, the masking component of the communicated signal should be minimized and non-interfering, reliable security, personally adjustable by each user and applicable to nearly all situations/environments, including mobile and crowded situations. It should offer minimum annoyance and minimize the distraction to other people (in the vicinity of the conversation and masking) that may be created by transmitting the masking signal. It may be beneficial if the apparatus and methods provides one or more of individual/personal/specific situation-adaptive user control of their masking; where the masking device only masks or covers when secure conversation is desired; when the person is talking; at a slightly higher sound volume (controllable) than the speech to be protected; the specific speech characteristics (adaptive speech feature masking); in the same directions as the emitted conversation; and the conversation to non-desired listeners, while minimizing the masking signal component received by the listener at the other end of the communications device. The masking techniques in addition to providing personally controllable/adaptive conversation masking may need to consider various costs/impacts; such as one or more of: ease-of-use to the person talking, annoyance to others, implementation in/with existing communications devices, installation, infrastructure investments, portability, maintenance/management, or the like.

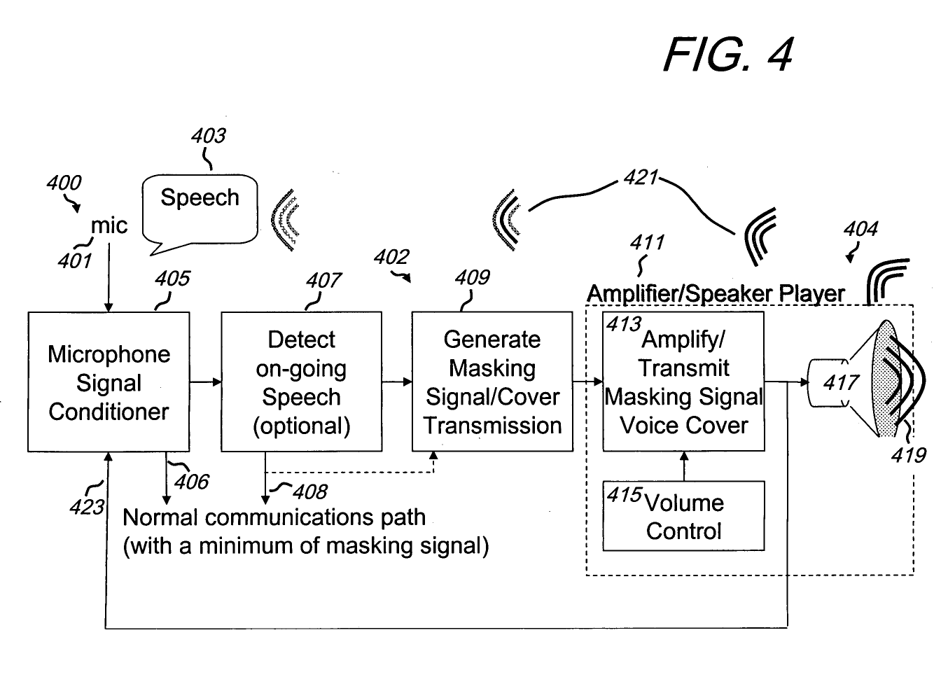

Referring to FIG. 4, a simplified and representative block diagram of an apparatus for masking speech signals according to various embodiments will be discussed and described. The FIG. 3 depicts one embodiment of an apparatus that provides or enables personal conversation privacy. The apparatus of FIG. 4 is arranged and constructed for masking speech signals. Generally, the apparatus includes an input section 400 that is configured to provide a signal corresponding to a speech signal; a masking generator 402 configured to generate a masking signal that adaptively corresponds to the signal; and a transducer 404 configured to provide, proximate to a source of the speech signal, an audible masking transmission corresponding to the masking signal, wherein the audible masking transmission adaptively masks the speech signal.

In the FIG. 4 embodiment, the input section 400 includes a microphone 401 that converts speech 403 (as well as any other acoustical energy in the vicinity) to a microphone signal in a known manner using widely available microphone cartridges to provide the signal corresponding to the speech signal. The microphone 401 is coupled to a microphone signal conditioner 405 that may comprise, for example microphone amplifiers, filters for limiting and shaping the microphone signal, or the like and in some embodiments will include a known adaptive filter that is arranged to remove or reduce any portions of the signal or microphone signal that correspond to the masking signal. One output of the signal conditioner can be a normal and conditioned signal at 406 for further processing according to one or more known techniques, such as may be utilized in one or more of the forms of communication devices noted earlier. The signal conditioner 405 and thus a signal corresponding to the speech signal is coupled to an optional detector 407.

The detector 407 is configured to determine whether the signal is active, i.e., whether the signal or speech signal is present, and if so the transducer provides the audible masking transmission. The detector can be fashioned with known techniques, similar to those used in speaker phones or hands free circuitry in communication devices, e.g., comparing short term average energies to longer term average energies in one or more frequency bands. The detector can operate to enable the masking generator 409 when the signal is active either with an enable signal, e.g., with enable signal at 408, or in some embodiments by coupling the signal corresponding to the speech signal to the masking generator 409 for further processing. The enable signal at 408 may be used for other functions in various forms of communication devices. Thus the audible masking transmission may only be provided or transmitted when speech is present.

The masking generator 402 comprises a basic masking generator 409 that may be coupled to an audio band amplifier 413. The masking generator 402 or basic masking generator 409, in varying embodiments, is configured to generate a masking signal that adaptively corresponds to an energy distribution of the signal (signal corresponding to the speech signal) and thus an energy distribution corresponding to the speech signal. The masking generator and corresponding processes create a masking signal that is incoherent or unintelligible relative to the speech signal, but possesses a similar energy distribution as the speech signal in space, time, volume, frequency and variability across one or more of these dimensions. Thus less power needs to be used to provide an effective masking transmission and hence less annoyance to bystanders and less impact on battery life will be experienced. Various base signals, such as noise of varying forms, one or more tones, or the like can be processed by the masking generator to provide or generate the masking signal that adaptively corresponds to the signal or speech signal. Additionally and in many embodiments the signal corresponding to the speech signal can be processed in order to generate the masking signal.

For example, the masking generator 409 can be configured to facilitate one or more transformations of portions of the signal, where the transformations are selected from temporally reversing, frequency shifting, squaring, amplitude compressing, delaying, copying, clipping, and changing the amplitude of the portions of the signal. Good masking results can be obtained when the masking generator is further configured to facilitate one or more of a different combination and a different sequence of the transformations on different portions of the signal. In some embodiments, the masking generator can be implemented as a signal processor using a general purpose microprocessor or digital signal processor. The masking generator 409 is configured to facilitate: parsing the signal into a plurality of time segments of the signal; transforming the plurality of time segments of the signal to provide a plurality of transformed time segments of the signal, each of the plurality of transformed time segments of the signal adaptively corresponding, respectively, to each of the plurality of time segments of the signal; and combining the plurality of transformed time segments of the signal to provide the masking signal.

In some embodiments, the masking generator can include: an analog to digital converter for providing digital samples of the signal; a buffer arranged to store a sequence of the samples of the signal; a processor for controlling the buffer to, for example, retrieve the sequence of samples at a variable retrieval rate and transform at least a portion of the sequence of samples to provide a transformed sequence of samples; and a digital to analog converter to convert the transformed sequence of samples to provide the masking signal. In other exemplary embodiments, the masking generator can sample the signal at a sample rate to provide a sampled signal and convert the sampled signal back to analog at a rate that differs from the sample rate to generate the masking signal. The masking generator can sample the signal at a sample rate that varies over time to provide the sampled signal and convert the sampled signal back to analog at a rate that varies over time to generate the masking signal. The embodiments noted above for the masking generator can readily be implemented with known signal processing techniques. Certain techniques will be further reviewed below.

The transducer 404 will include a speaker 417 which can be a separate speaker, or in the case of a communication device may be a ring tone speaker or the like. The speaker 417 will be coupled to the amplifier 413 which is coupled to and arranged to amplify the masking signal and to drive the transducer or speaker 417 and may be configured to provide two or more different output levels for the masking transmission 419 responsive to the volume control 415. Note that the volume control may further include a user control for controlling, e.g., enabling or disabling, the apparatus of FIG. 4. In many embodiments, e.g. communication devices, etc., the transducer is arranged to direct the audible masking transmission 419 away from the microphone 401, and thus the apparatus of FIG. 4 is thereby configured to mask speech from at least one side of a conversation between a plurality of users or parties to the conversation.

Note that a portion 421 of the masking transmission may end up being picked up by the microphone 403, depending on particular arrangements of the speaker, microphone, surrounding environment and so on. By providing the masking signal, from for example, the output of the amplifier or the output of the masking generator 409 (not shown and may require an amplitude adjustment corresponding to the gain of the amplifier) to the signal conditioner 405 at 423 an adaptive filter (included with signal conditioner 405) using the signal at 423 as a reference can be arranged and configured in a known manner to eliminate or reduce any portion of the signal from the microphone that corresponds to the masking transmission or signal. Note that the apparatus of FIG. 4 may be used in conjunction with a communication device, e.g., one or more of a portable device, a cellular phone, a public safety radio, a satellite radio, a military radio, or the like.

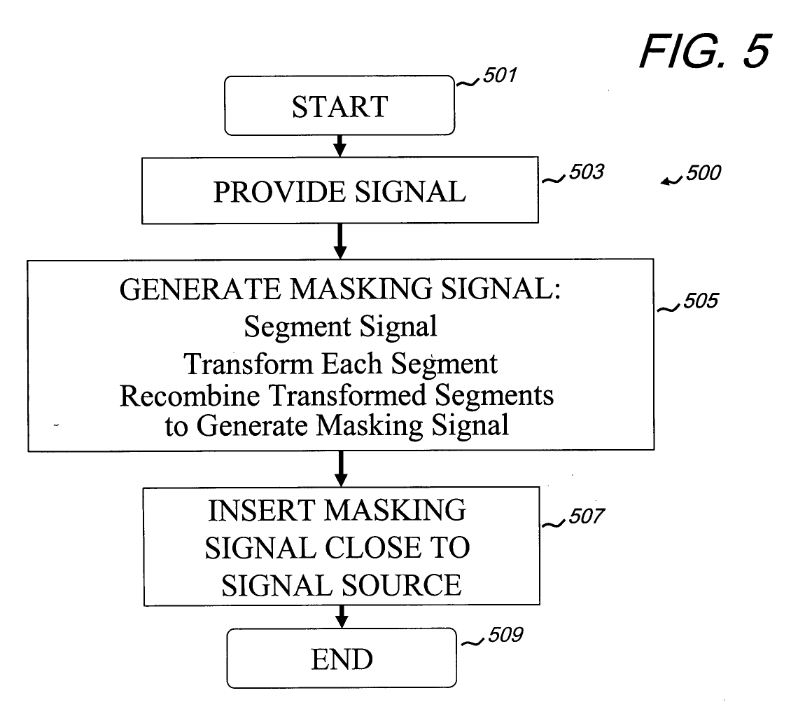

Referring to FIG. 5, a flow chart of a method of adaptively masking signals will be discussed and described. The method of FIG. 5 and similar methods can be practiced using the apparatus of FIG. 4 as well as other apparatus similarly configured and arranged. The method begins at 501 and then providing a signal 503, e.g. a signal corresponding to an audible signal such as a signal corresponding to a speech signal that may be available from a transducer or microphone is shown. Given the signal, the method next includes generating a masking signal 505 that adaptively corresponds to the signal, e.g. corresponds to an energy distribution of the signal. One technique for generating the masking signal is suggested at 505 and includes segmenting or parsing the signal into a plurality of time segments of the signal, transforming the plurality of time segments of the signal to provide a plurality of transformed time segments of the signal that adaptively correspond, respectively to each of the plurality of time segments of the signal, and then combining the plurality of transformed time segments to provide the masking signal. Given the masking signal, the method then includes inserting the masking signal 507 into a channel corresponding to the signal at a location near or proximate to the source of the signal to thus facilitate masking the signal in the channel. For example, as noted above with reference to FIG. 4, the masking signal is inserted at a point close to a microphone as a masking transmission into a channel along with a speech signal, where the channel is, for example, between the person generating the speech signal and an eavesdropper.

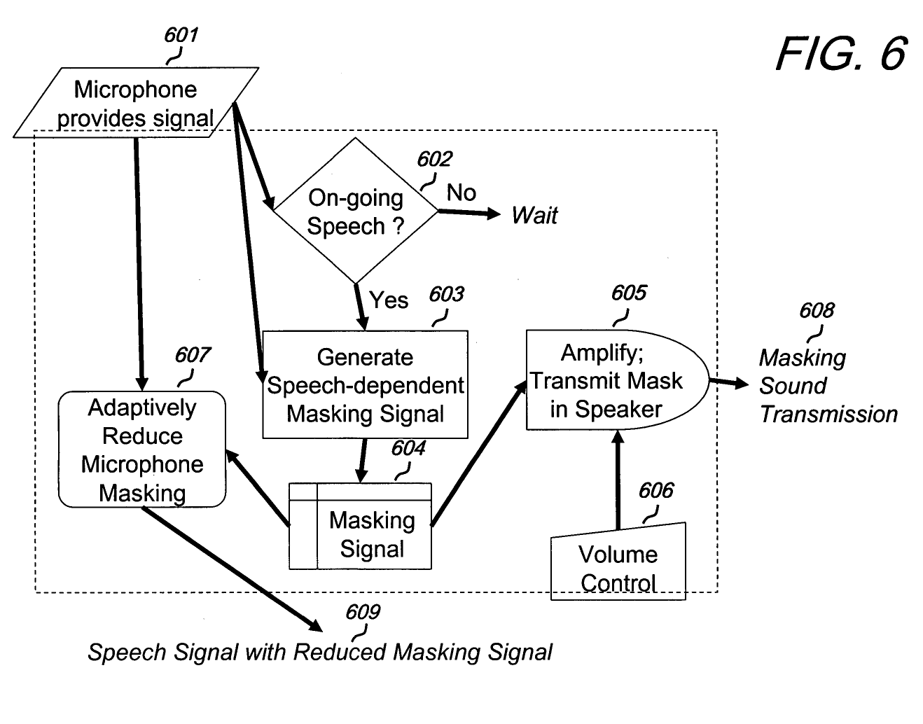

Referring to FIG. 6, a more detailed diagram including a flow chart of a method similar to the method of FIG. 5 will be discussed and described. The method of FIG. 6 shows one embodiment of a conversation privacy/personalized speech masking process, e.g. method of masking signals. As an overview, to efficiently mask and adapt to the speech as it is spoken, a microphone 601 is a Speech Sensor that transforms the speech into and thus provides a signal that can be processed. The signal, i.e. signal corresponding to the speech or a speech signal from the microphone 601 follows various paths; the speech signal can always and immediately be used to generate the masking signal 603 or the speech signal can be passed to 602 to determine whether speech is occurring. If speech is not on-going, then masking may not be transmitted, i.e., generation of the masking signal is not enabled (YES branch not enabled at 602). If 602 detects the presence of speech at the microphone, i.e., if speech is detected as on-going, then the speech masking processes and components are engaged.

One of these processes is to generate a Speech-adaptive Masking Signal 603. This process creates a masking signal that is incoherent/unintelligible relative to the speech signal, but possesses a similar energy distribution as the speech signal in one or more of space, time, volume, frequency and variability across these dimensions and thus adaptively corresponds to the signal. This Masking Signal 604 will be passed to the Amplify/Transmit Mask in Speaker process 605. A Volume Control process 606 specifies or sets the gain of an amplifier applied to the masking signal for transduction in a speaker. The Amplify/Transmit Mask in Speaker process 605 amplifies and converts the Masking Signal 604 into propagating audio, i.e., a masking or masking sound transmission or audible output signal 608, to cover/protect the speech sensed by the microphone, i.e., spoken conversation. Thus the method of FIG. 6 includes providing a signal, e.g., from a microphone, the signal corresponding to a speech signal and then generating a masking signal and inserting the masking signal into a channel corresponding to the signal by coupling the masking signal to a speaker that is proximate to the microphone to generate an output audible signal that adaptively masks the speech signal. The amplitude of the masking signal that is coupled to the speaker can be changed or varied as appropriate.

The method of FIG. 6 may further comprise filtering the signal to remove portions of the signal corresponding to the audible signal that is output from the speaker as a masking transmission and end up being coupled back to the microphone. An Adaptively Reduce Microphone Masking process 607 utilizes the Masking Signal 604 as the reference signal in an adaptive filter to minimize the Masking Signal 604 component in the output speech signal 609, e.g., output audio signal for, e.g., transmission to a remote user. This reduction process is an optional process that normally would not be required in a stand-alone conversation privacy device. The outputs from this speech masking process are the speech-sensitive, Masking Sound, e.g., masking transmission 608 and the output speech signal 609, i.e., Speech Signal with Reduced Masking Signal 609. Note that this method may be implemented in conjunction with a communication device, e.g. as a supplementary or add on device or in a more or less fully integrated form using existing analog to digital and digital to analog converters, processing resources, microphones, and a ring tone speaker or auxiliary speaker or the like.

Note that the processes 601, 603, 605 correspond to the more general flow chart of FIG. 5. Note that the process at 602 as part of providing an audible signal comprises determining whether the audible signal is active and when the audible signal is active the generating the masking signal that adaptively corresponds to the signal occurs and inserting the masking signal as a masking transmission into the channel 605 takes place. The method via the process at 603 includes generating the masking signal and this further comprises processing the signal to provide a masking signal that corresponds to an energy distribution of the signal, e.g., adaptively corresponds to the signal over time and/or over frequency or the like. Note that some embodiments may include processing the signal to provide a masking signal that corresponds to an energy distribution of the signal by further processing a noise or noise like signal to provide a masking signal the adaptively corresponds to the energy distribution of the signal.

Various embodiments for generating the masking signal are contemplated. For example in some embodiments the processing the signal to provide a masking signal that adaptively corresponds to an energy distribution of the signal further comprises: parsing the signal into a plurality of time segments of the signal; transforming the plurality of time segments of the signal to provide a plurality of transformed time segments of the signal, each of the plurality of transformed time segments of the signal adaptively corresponding, respectively, to each of the plurality of time segments of the signal; and combining the plurality of transformed time segments of the signal to provide the masking signal. The transforming the plurality of time segments of the signal further comprises for each of the plurality of time segments of the signal one or more transformations, where the transformations are selected from temporally reversing, frequency shifting, squaring, amplitude compressing, delaying, copying, clipping, or changing the amplitude of the time segment of the signal or the like. Note that a first and a second of the plurality of time segments of the signal can be transformed using one or more of a different combination or a different sequence of the one or more transformations noted above.

The processing the signal to provide a masking signal that corresponds to an energy distribution of the signal, in some embodiments can include recording the signal at one or more recording rates to provide a recorded signal; and providing the masking signal by playing the recorded signal at a rate different from the one or more recording rates, where the recording rates and the playing rate may each be independently changing over time but should be selected to be different at any one point in time. Note that in some embodiments the processing the signal to provide a masking signal that adaptively corresponds to an energy distribution of the signal can include sampling the signal at one or more sampling rates to provide a sampled signal and providing the masking signal by converting the sampled signal at a rate different from the one or more sampling rates, where again the sampling rate and conversion rate may vary or change over or across time and should not be equal at any one point in time.

Thus FIG. 6 shows a method wherein: the providing the signal further comprises providing a signal generated by a microphone responsive to an audible signal from for example, a person that is speaking; generating a masking signal further comprising generating a masking signal that corresponds to an energy distribution of the signal generated by the microphone; and inserting the masking signal into the channel further comprising coupling the masking signal that corresponds to an energy distribution of the signal generated by the microphone to a transducer that is proximate to the microphone to provide an audible masking signal.

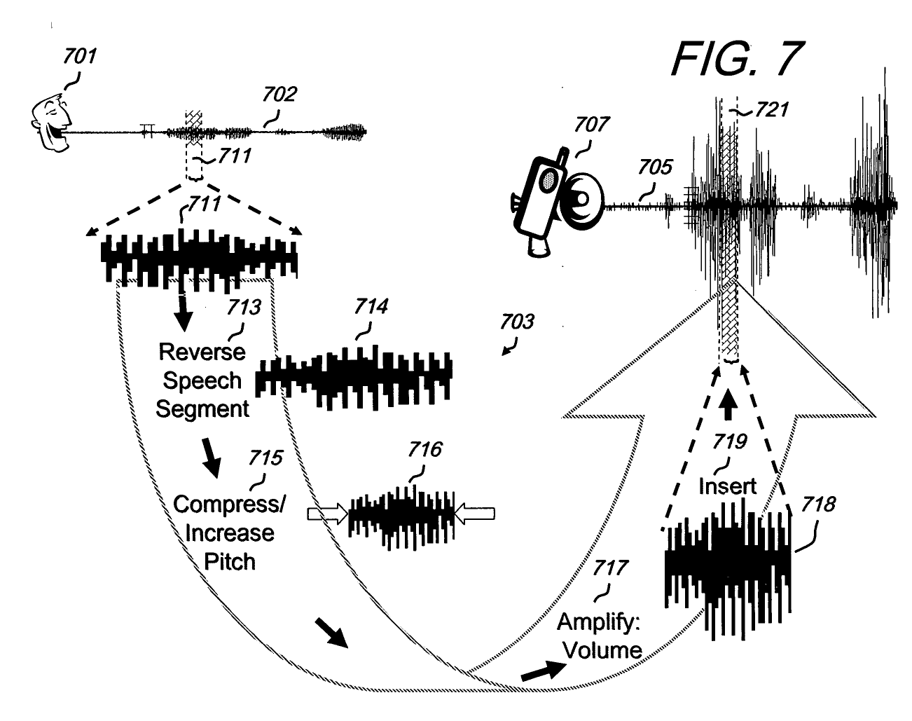

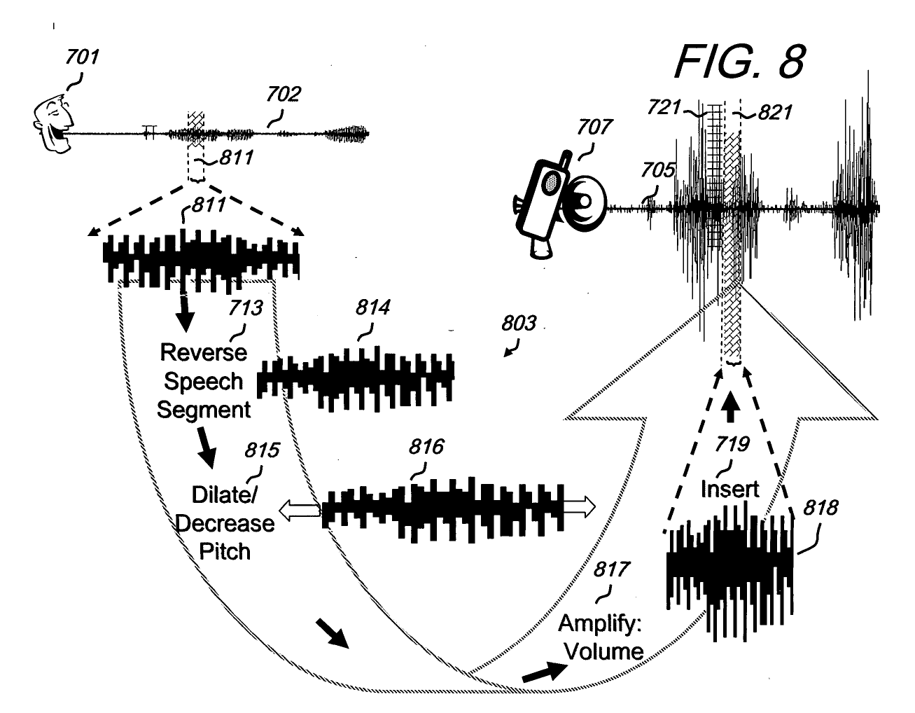

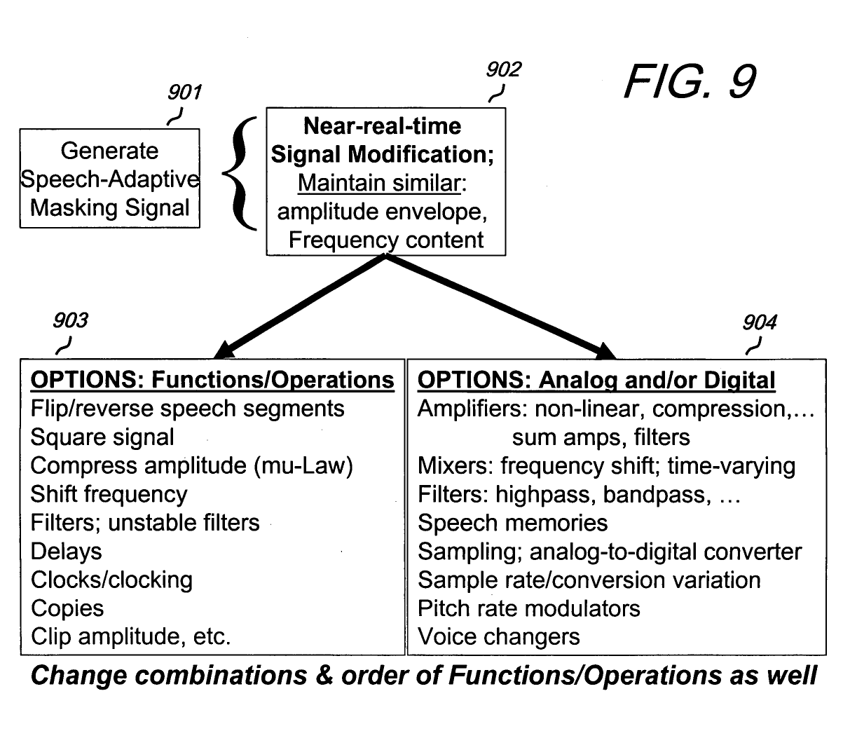

More detailed embodiments of generating the masking signal, etc. will be provided below by way of example. Referring to FIG. 7 and FIG. 8 collectively and FIG. 7 initially an exemplary process for generating a masking signal and thus masking transmission or output audible masking signal will be discussed. FIG. 7 displays a method for generating the speech-sensitive or speech-adaptive masking signal. The masking signal generation process starts with the person 701 speaking and thus creating speech 702. When the person desires conversation privacy for their speech 702 a voice masking process 703 is implemented to provide a speech masking signal or masking transmission 705 that is provided from a speaker 707 (the speaker may be part of a communication device that the person 701 is using. The voice mask generation process has many potential realizations and alternatives. One embodiment of the masking signal generation shown in this figure breaks or parses the speech into segments, with segment 711 shown. Each speech segment 711, which is a short, “time chunk,” usually on the order of several milliseconds, e.g., 2-100 ms, is transformed to create a segment 721 of the speech masking signal 705. By transforming a segment of the person's speech 702 into a corresponding segment of the voice masking signal 705, the masking signal 705 can maintain many of the characteristics of the person's speech 702 so that it efficiently and effectively covers the speech 702 and confuses any listeners.

In FIG. 7 the speech segment 711 is transformed by applying a series of operations: time reversal or flipping 713, time compression or pitch rate increasing 715, and amplification or amplitude gain 717. The time reversing operation/transformation 713 reverses the order of the signal or can be envisioned as flipping it horizontally to provide the reversed segment 714. The time compression or pitch rate increasing 715 operation/transformation can be envisioned as squishing the signal or playing the signal at a faster rate, causing the pitch or frequencies to increase which results in the faster rate segment 716. Note that approximately a 10% pitch change, i.e., a time scale compression in the vicinity of 1.1, may be appropriate and the net result is a segment that may play for less time than the original segment. The amplification or amplitude gain 717 operation or transformation realizes a multiplication function and can be envisioned as changing the vertical or height of the input signal by the same multiplier or gain and provides or creates the voice masking segment 718. The voice masking segment 718 or resulting transformed speech segment is now inserted 719 as a segment 721 of the composite voice masking signal 705. This segment 718 will be combined with previous and subsequent voice masking segments to construct the composite voice masking signal 705. Thus, speech-sensitivity or adaptivity is realized by utilizing the input speech 702 as the basis of the voice masking signal 705. This masking signal generation process creates the functionality required for a voice masking device, such as the speaker and communication device, i.e., a virtual masking megaphone 707.

FIG. 8 displays a continuation from FIG. 7 of a process for generating the speech-sensitive or speech-adaptive masking signal and thus masking transmission. The masking signal generation process starts with the person 701 who desires conversation privacy for their speech 702. The mask generation process portrayed in FIG. 8 simply changes the parameters in the speech-to-masking transformation process 803 relative to the parameters in FIG. 7. Two parameters, the compression/pith rate 815 and the amplification/gain 817 are different than the corresponding processes of FIG. 7. Otherwise, the transformation process remains the same as the previous figure. Alternatively, other parameters as well as operations/functions can be changed, inserted, removed, re-ordered, etc. In FIG. 8 speech segment 811 (next sequential segment after segment 711) is transformed into a voice masking segment 821 (next in sequence after 721 with a different and varying process/transformation. Generally, each speech segment is transformed to create a segment of the voice masking signal 705.

In FIG. 8 the speech segment 811 is transformed by applying a series of operations, time reversal or flipping 713, time dilation or pitch rate decreasing 815, and amplification or amplitude gain 817. The time reversing operation/transformation 713 reverses the signal or can be envisioned as flipping it horizontally to provide reversed segment 814. The time dilation or pitch rate decreasing 815 operation or transformation can be envisioned as stretching the signal or playing the signal at a slower rate to provide stretched segment 816, causing the pitch or frequencies to decrease. The amplification or amplitude gain 817 operation or transformation realizes a multiplication function and can be envisioned as changing the vertical or height of the input signal by the same multiplier or gain. The resulting transformed speech segment, i.e., masking segment 818, after insertion 719 and realized via the speaker 707 is now a segment 821 of the voice masking signal 705. Thus, speech-sensitivity or adaptivity is realized by utilizing the input speech 702 as the basis of the voice masking signal 705.

One embodiment of the transformation process 703, 803 simply records or samples the speech signal at a relatively low rate or frequency (or utilizing an existing microphone recording at a higher sampling rate). Suppose this recording/sampling is performed for a short time to provide a segment. Then this segment is time-scaled (compressed or dilated) by a factor in the range of 1.1 or 0.9 to realize a significant, but not overwhelming frequency/pitch shift of that segment. In FIG. 8, a time-dilation is represented that decreases the pitch of the segment. The new segment is actually longer in time and thus may play for longer in the masking signal. A mixer could be used to realize a similar transformation. The time-scales/pitch-shifts should be varying rapidly and may not be in a regular pattern; otherwise annoying tonal sounds may occur in the masking signal. The size of the segments may also change across time to further reduce any annoying tonal sounds in the masking signal.

The simplified diagram of FIG. 9 shows various alternative transformations that may be used to generate a speech-adaptive masking signal 901. The generation process 901 in FIG. 9 utilizes the microphone-sensed signal to create an efficient and effective Masking Signal. To efficiently generate a Masking Signal that is highly focused to mask the on-going speech, this invention utilizes the sensed speech signal as the basis for the masking signal. The functional block of Near Real-time Signal Modification 902 comprises a combination of one or more Transforms/Operators/Functions 903 that are applied to the sensed-speech signal to transform it into a masking signal that is unintelligible and incoherent with the speech signal. However, these transformations should not transform the speech signal too much as the masking and speech signal should possess similar space/time/frequency/volume/dynamic characteristics, i.e. the masking signal should adaptively correspond to the speech signal. Otherwise the energy devoted to masking would not be efficiently utilized to mask/cover the speech signal. The Transforms/Operators/Functions 903 can be applied to the microphone-sensed speech signal with one or more Analog and/or Digital means, as listed under the OPTIONS: Analog and/or Digital 904.

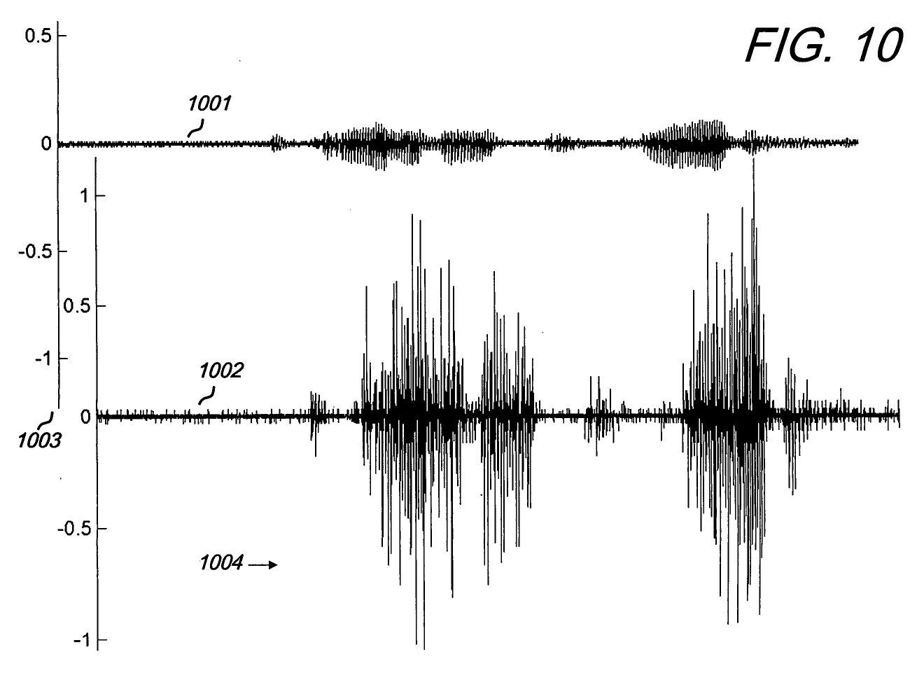

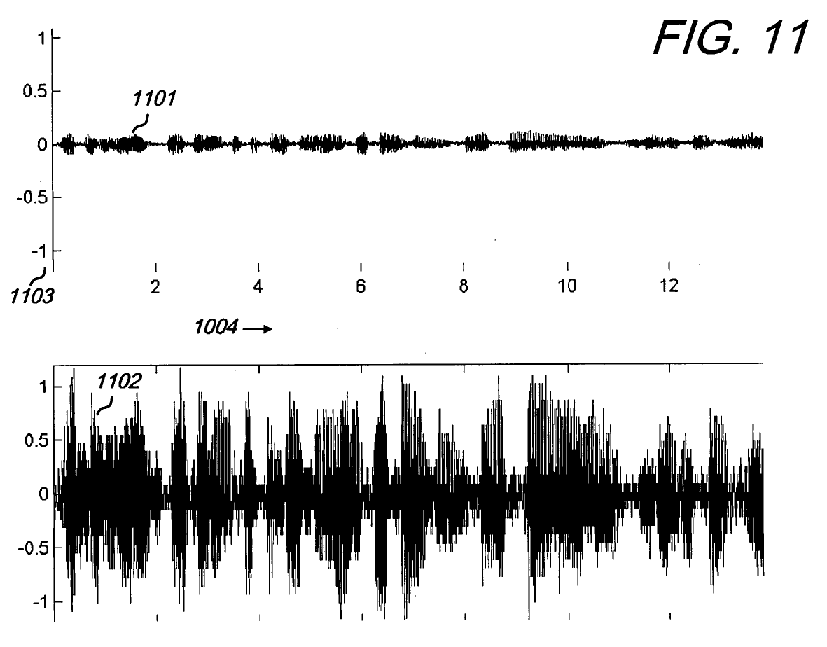

Referring to FIG. 10, an exemplary speech signal and a masking signal adaptively corresponding thereto is depicted. This particular realization of the voice masking waveforms illustrate a waveform 1001 corresponding to an uttered speech signal (“its all about the dragon”) and a waveform 1002 representing the corresponding voice masking signal as a function of amplitude 1003 (vertical axis) versus time 1004 (horizontal axis). Note the correspondence/correlation between the speech and masking waveforms. Those of ordinary skill will recognize the waveforms have a similar amplitude envelope, similar variability and similar frequency content, i.e. an energy distribution that is correlated and similarly distributed over time and frequency. These similarities help minimize the masking energy that is required to adequately/sufficiently mask (render unintelligible) the speech. Also note that the amplitude of the masking signal is consistently higher than that of the speech signal.

Referring to FIG. 11, another exemplary speech signal and a masking signal adaptively corresponding thereto is depicted. This particular realization of the voice masking waveforms illustrate a waveform 1101 corresponding to an uttered speech signal over a longer period of time and a waveform 1102 representing the corresponding voice masking signal as a function of amplitude 1103 (vertical axis) versus time 1104 (horizontal axis). The voice masking signal was generated using segmenting, time scaling, and amplifying similar to the processes noted above with reference to FIG. 8 and FIG. 9. As in FIG. 10, note the correspondence/correlation between the speech and masking waveforms. Those of ordinary skill will recognize the waveforms have a similar amplitude envelope, similar variability and similar frequency content, i.e. an energy distribution that is correlated and similarly distributed over time and frequency. These similarities help minimize the masking energy that is required to adequately/sufficiently mask (render unintelligible) the speech. Also note that the amplitude of the masking signal is consistently higher than that of the speech signal.

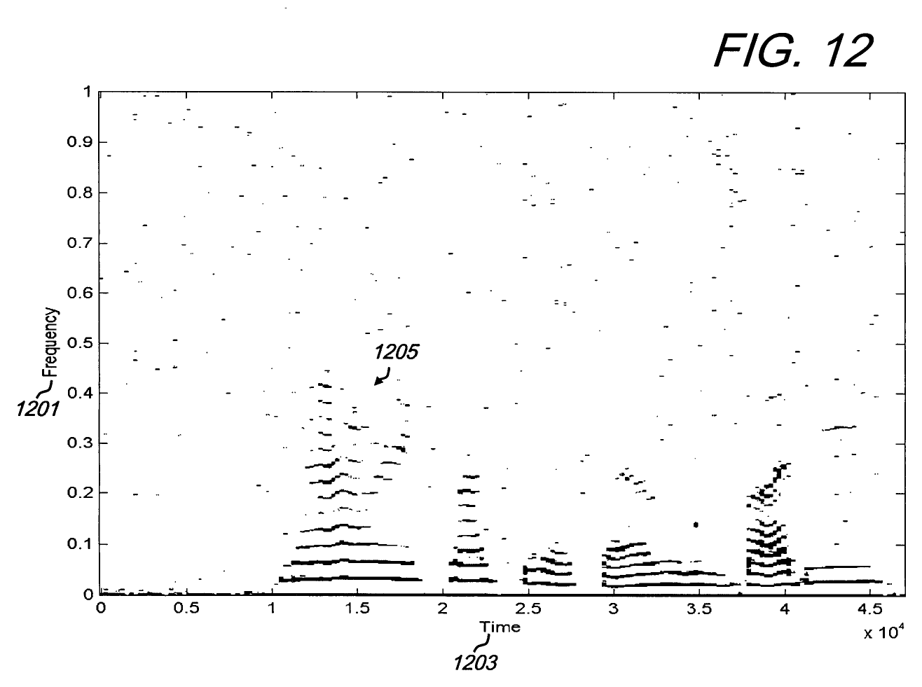

Referring to FIG. 12, a speech spectrogram (known voice analysis tool for analyzing time varying frequency components of a signal) displays the frequency content 1201 of a speech signal on the vertical axis as a function of time 1203 on the horizontal axis. The darker color represents the stronger components of the signal, or frequencies at particular times that have significant energy. This speech signal is about 2.2 seconds long and is sampled at approximately 22,000 samples per second. Note that the initial set of dark stripes 1205 on the left side of the drawing has about 15 stripes of varying lengths in time, as well as some variations. The sections of the speech representing vowel segments (vowel phonemes or formants) usually possess this structure where multiple frequencies are excited at one instance in time. The vowel sounds are recognized by hearing these different frequency components and their consistent relationships. Younger speakers and women often have higher frequency content for each stripe (formant) but the relative structure of the stripes conveys the vowel sound, rather than the absolute frequencies of each stripe.

Those of ordinary skill in the field typically refer to speech structure in terms of phonemes, i.e., the separable, comprehensible, significant speech components or the multiple, simultaneous, time-varying, time-frequency components of the speech as may be determine from a spectrogram. Individual primary frequency components of vowel or vowel phonemes are referred to as formants, e.g. dark stripes 1205, or vowel formants. FIG. 12 displays many phoneme features as well as phoneme transition features. Vowel phonemes, and their corresponding frequency components, or formants, though not particularly evident given the scale of the vertical axis are often featured in the 0.05-0.1 frequency region where darker, usually sloped, “lines/curves” are evident. The formant structure of a vowel phoneme 1205, as shown, usually has multiple simultaneous time-frequency components (lines/curves) that vary (are sloped) even across the duration of the vowel. Speech comprehension or intelligibility can be expressed in terms of phoneme comprehension. Conversation privacy performance can be expressed by eavesdropper speech/phoneme comprehension. Bystander annoyance performance can be expressed in terms of transmitted energy or power levels.

Adaptive masking or speech adaptive masking may be thought of as focusing masking transmissions on the specific significant speech features, such as the specific frequency components of each individual vowel utterance, or formant; and/or on each phoneme (significant speech components) transition. Speech-adaptation or adaptive masking efficiently utilizes the masking energy by concentrating the transmissions directly on the significant speech components, effectively deterring eavesdroppers but with reduced annoyance to bystanders. Thus, efficient sound masking, i.e., conversation privacy, with low bystander annoyance focuses the transmitted sound onto significant speech components, or phonemes, of the on-going speech utterances. In a sense, phonemes of the on-going speech are utilized to generate the masking signal, however advantageously detection or characterization of the phonemes is not required. Merely utilizing the on-going speech (which has the energy concentrated in phonemes) to generate the masking signal (speech adaptive) serves the purpose. Thus, the method of simply acquiring the speech in time segments, then transforming, i.e. time scaling, reversing, amplifying, or the like each segment as it is played to generate the masking signal for transmission, realizes the “speech-adaptive” mask generation, with masking energy focused/concentrated upon on-going speech phonemes, but does not process the signal to characterize phonemes. The masking signal or transmission will demonstrate a similar energy distribution to that of the speech signal, i.e. the two energy distributions will be correlated or show correspondence.

In addition to the other techniques noted herein low-cost, existing, voice changers that simply shift the frequency or pitch of the speech and then retransmit it can be used to provide an appropriate masking transmission, for example, by combining or stacking two voice changers, i.e. by placing the microphone of the second voice changer in close proximity to the output speaker of the first voice changer. Both voice changers shift the pitch/frequency of their respective inputs. However, in addition the speech is transformed by the near-field conversion at the second voice-changer microphone/first voice-changer speaker conversion process. The extent of the degradation changes with the positioning of the microphone relative to speaker. The masking signal that is generated has the phonemes of the original speech but they are delayed as well as frequency/pitch-shifted; however, the near field, voice changer speaker/microphone transduction process also nonlinearly modifies the speech signal to create the masking signal. Thus, none of the phonemes are detected/characterized, but the generated masking signal possesses concentrates/focuses its energy onto the significant speech components of the on-going speech. Therefore, low annoyance-to-bystander, but highly efficiency conversation privacy is achieved with simple transformations of the sensed speech process to generate the masking signal for amplified transmission.

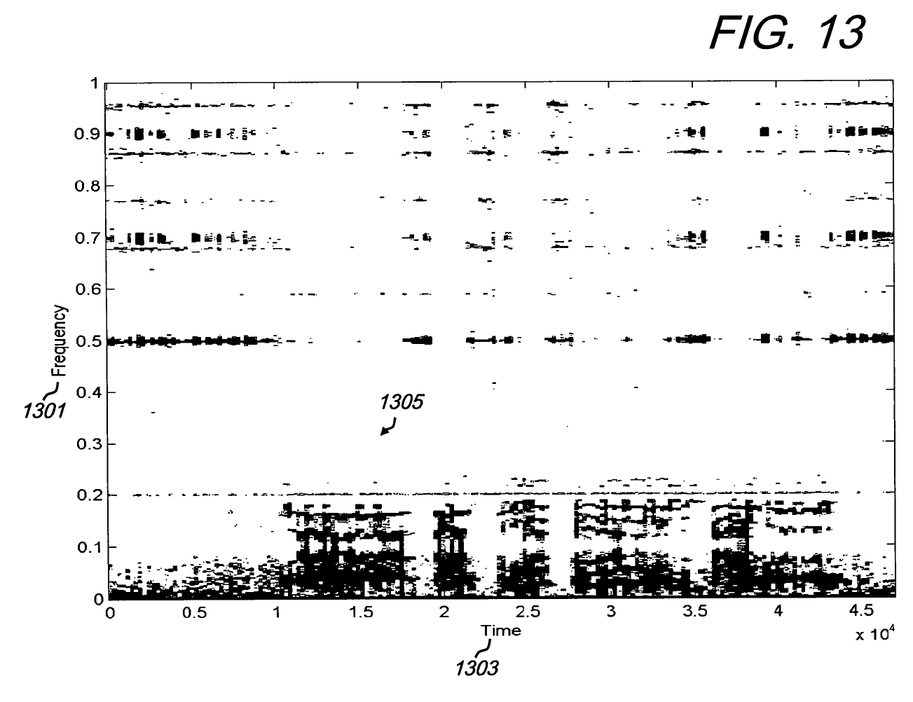

Referring to FIG. 13, a spectrogram of the masking signal corresponding to the speech signal of FIG. 12 displays the frequency content 1301 of the masking signal on the vertical axis and time 1303 on the horizontal axis where the horizontal and vertical axis uses the same scale as FIG. 12. The darker color represents the stronger components of the signal, or frequencies at particular times that have significant energy. This masking signal is about 2.2 seconds long and is sampled at approximately 22,000 samples per second. Note that the initial set of dark stripes 1305 on the left side of the drawing has only about 4-5 stripes or frequencies. Also note that frequencies above 0.2 are heavily attenuated relative to the original speech signal spectrogram of FIG. 12. The higher frequency components of the original speech signal have “aliased” into the lower frequencies causing confusing relationships between the frequency components. This limiting of frequencies and aliasing of energy from higher frequencies into lower frequencies results from under sampling the speech signal without appropriate lowpass filtering. For masking signal generation, this aliasing of confusing energy into inappropriate bands may be desirable and effectively interferes with the speech signal. Note however that this attenuation of higher frequencies is not necessary and the cutoff (corresponding sampling frequency) can be arbitrarily adjusted for desirable performance.

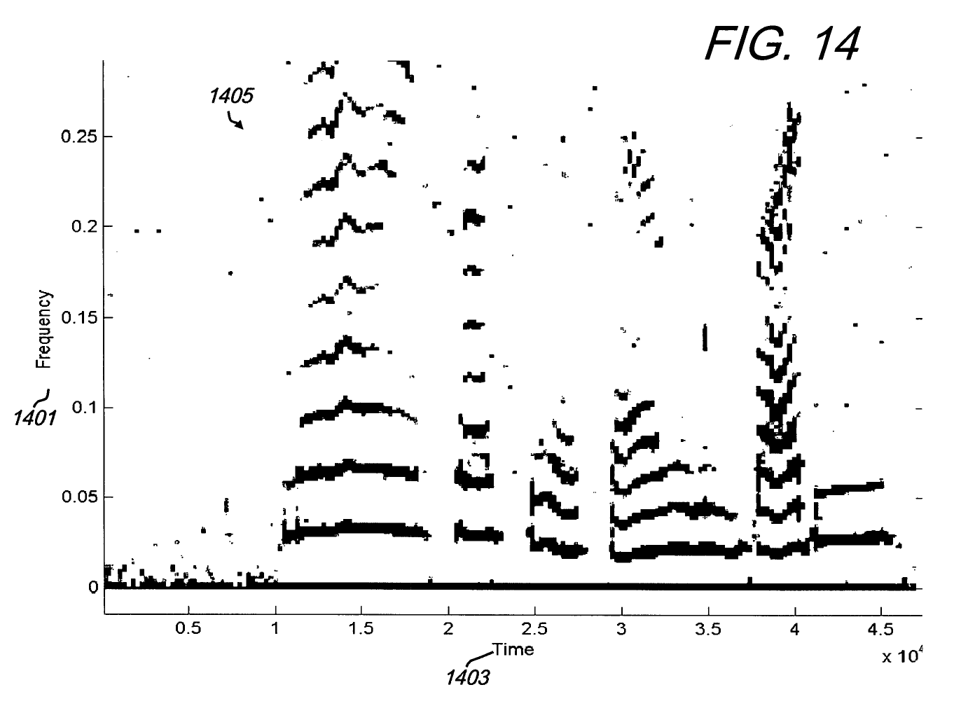

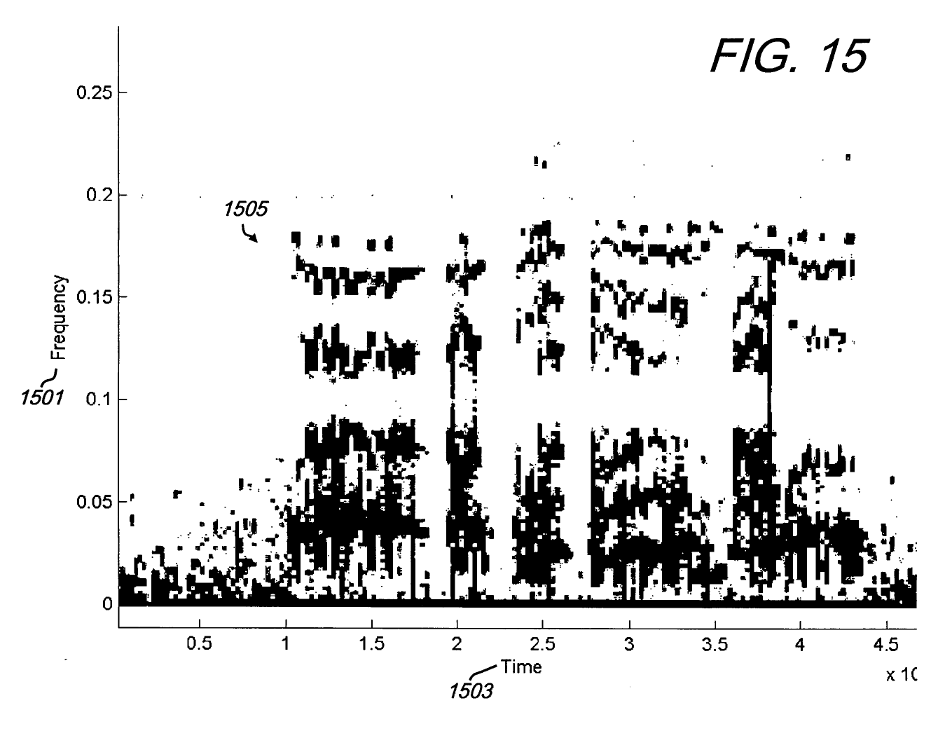

FIG. 14 and FIG. 15 depict, respectively, a spectrogram of the speech signal of FIG. 12 and the masking signal of FIG. 13 with a different scale for the horizontal axis than was used in FIG. 12 and FIG. 13. The speech signal spectrogram of FIG. 14 displays the frequency content 1401 of the speech on the vertical axis and time 1403 on the horizontal axis. This is a zoomed in segment of the lower frequency components of the original speech signal spectrogram. The darker color represents the stronger components of the signal, or frequencies at particular times that have significant energy. This speech signal is about 2.2 seconds long and is sampled at approximately 22,000 samples per second. Individual frequency components are clear and the striped vowel structures or phonemes, e.g., formant's frequency structure 1405, etc., are distinguishable.

The masking signal spectrogram of FIG. 15 displays the frequency content 1501 of the masking signal on the vertical axis and time 1503 as the horizontal axis. This is a zoomed in segment of the lower frequency components of the masking signal spectrogram. The darker color represents the stronger components of the signal, or frequencies at particular times that have significant energy. This masking signal is about 2.2 seconds long and is sampled at approximately 22,000 samples per second. Now the aliased energy spreads across the band and the Individual frequency components or formants are more blurred. Note that the individual frequency stripes, e.g. formants 1505, have almost a “wavy” pattern. Because the masking signal is created by time-scaling (compressing or dilating) short time segments of the original speech signal, each frequency component of the masking signal is either shifted up (time compression during that short segment) or shifted down (time dilation during that short segment). However, since the time-scaling is never unity, the frequency components of the masking signal will always be offset from the original speech's frequency. Although the frequency components and structure of the masking signal will be similar to that of the original speech signal, they will always be distinguishably offset. Additionally, the offset changes throughout the duration of the masking signal. Thus, the speech signal is masked by similarly structured frequency components, but very few that reinforce, i.e., they just interfere and confuse any potential listener.

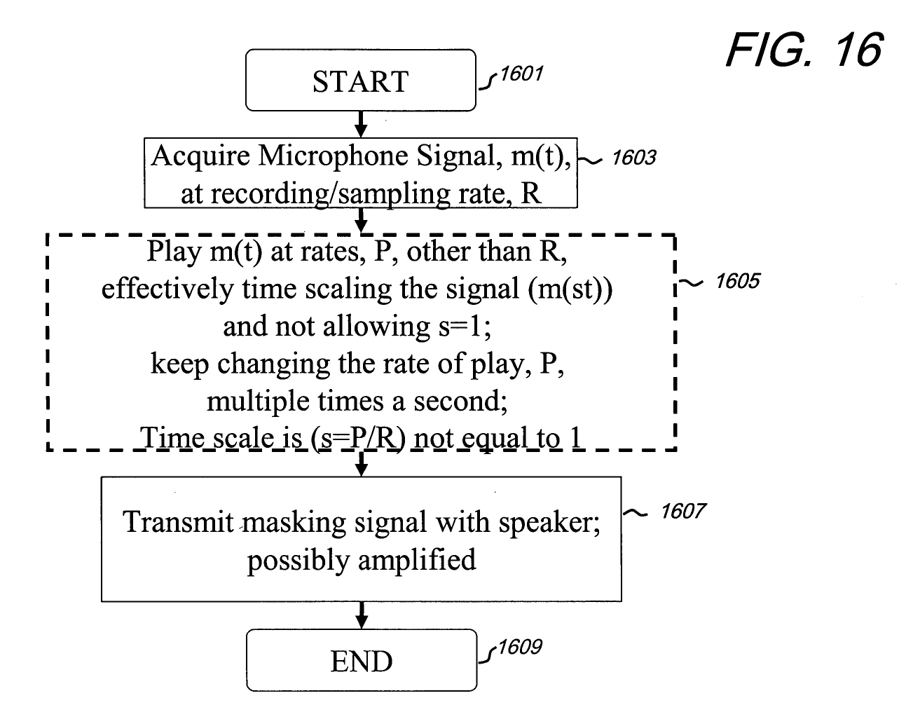

Referring to FIG. 16, a flow chart of a particular embodiment of a method similar to the FIG. 5 method, provides a masking signal for speech, thereby enabling personal privacy for an individual(s) using the method. The method can be implemented in various apparatus including ones discussed above or below. The method begins at 1601 and then acquires 1603 a signal from a microphone, m(t), at a recording or sampling rate, R. Note that R may change with time as earlier noted. Generating a masking signal 1605 includes playing m(t) as recorded at rate, R, at a rate, P (P not equal to R) thereby time scaling the signal to yield a time scaled signal, m(st) (s not equal to 1). As earlier noted, P/R typically may vary from 0.9 to 1.1, i.e., by 10% or so, but never equaling 1. As indicated the rate, P is constantly changing at several times per second (for example 5-500). Thus the signal from the microphone is processed to provide a masking signal that corresponds to or simulates an energy distribution of the signal by recording or sampling the signal at one or more recording rates (R) to provide a recorded signal and providing the masking signal by playing the recorded signal at a rate (P) different from the one or more recording rates where the rate R or P may vary or change across or with a change in time. The masking signal generated at 1605 is coupled to (possibly after amplification) a transducer, for example, a speaker and transmitted or broadcast from a position or location that is close or proximate to the microphone and ends at 1609. However the process or method may be repeated as needed and can be subject to user discretion as to when to enable or utilize the process.

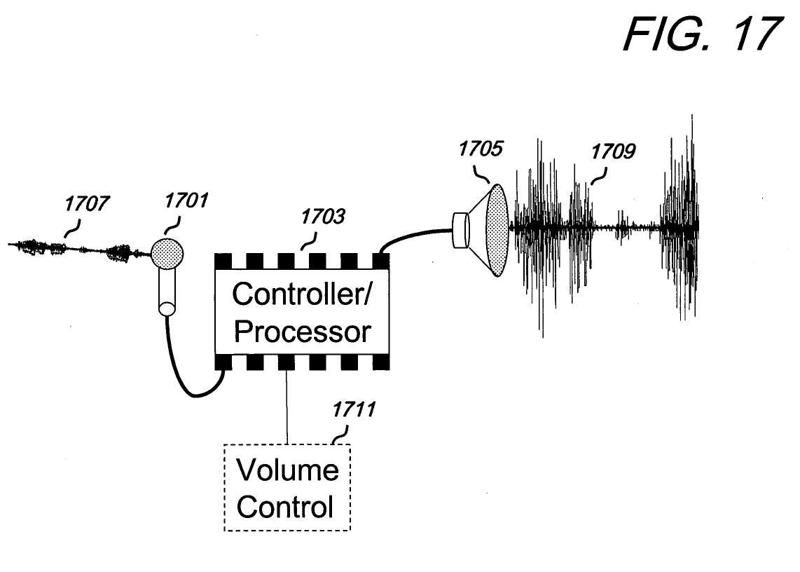

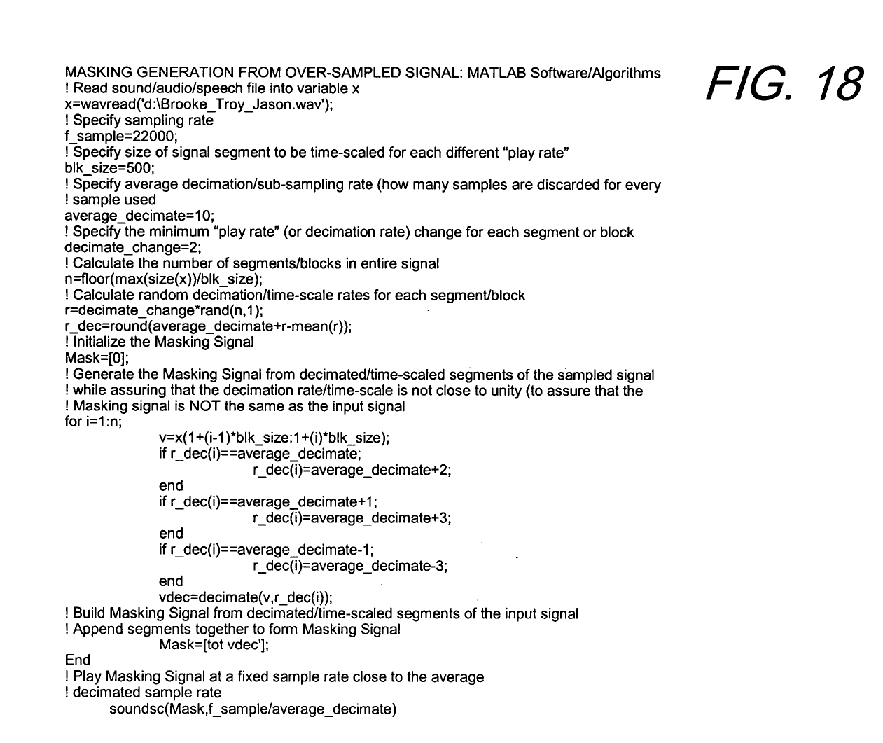

Referring to FIG. 17, a simplified physical embodiment suitable for practicing one or more methods in accordance with various exemplary embodiments will be described. FIG. 17 displays a particularly elegant embodiment. A microphone 1701, controller/processor 1703, and speaker 1705 are intercoupled as shown and may be either wholly and/or individually integrated with, for example a communications device or stand alone apparatus or component. They are collectively arranged to provide a masking signal and transmission to thereby facilitate personal conversation privacy or the like. The microphone 1701 is coupled to a speech utterance 1707 and provides a speech signal, e.g., m(t), corresponding to the speech utterance to the controller/processor 1703. The controller/processor 1703, for example a PIC controller available from Micro Chip includes an analog to digital converter, and operates to generate (using methods similar to method of FIG. 16 or others) the masking signal or masking transmission 1709 from the speaker 1705.

The controller 1703 can adjust an amplitude/volume of the masking transmission 1709 to create the appropriate masking level, responsive, for example, to the volume control 1711. This control may also provide on/off functionality for FIG. 17 apparatus. The amount of amplification varies depending upon the distance of the speaker from the microphone. A speaker who is further away will produce a smaller microphone signal than a person who is closer to the microphone but the person who is further away will require more amplification to effectively mask than the person who is closer to the microphone and produces a larger signal into the microphone. Thus, unless the speaker's distance to the microphone is known or can be estimated, an adjustable volume control may be desirable to account for the speaker's distance from the microphone. The adjustable volume control also enables the user to adaptively adjust their level of masking to assure sufficient oral/speech privacy/security. Note if the microphone includes an amplifier and the speaker is high enough in impedance such that a digital bit stream from the controller can be utilized to drive the speaker, FIG. 17 shows virtually all of the components, other than a conditioned power supply and appropriate housing that would be required to implement voice privacy.

Referring to FIG. 18, a listing of a MATLAB™ and sufficient comments to act as pseudo-code that may be utilized by the FIG. 17 embodiment to implement the method of FIG. 16 is shown. The pseudo-code listing is self explanatory to those of ordinary skill and includes sampling a speech file at a sample rate, segmenting the sampled signal, choosing a decimation rate and random change in the rate, generating a masking signal from each segment, building the overall masking signal, and playing the overall masking signal.

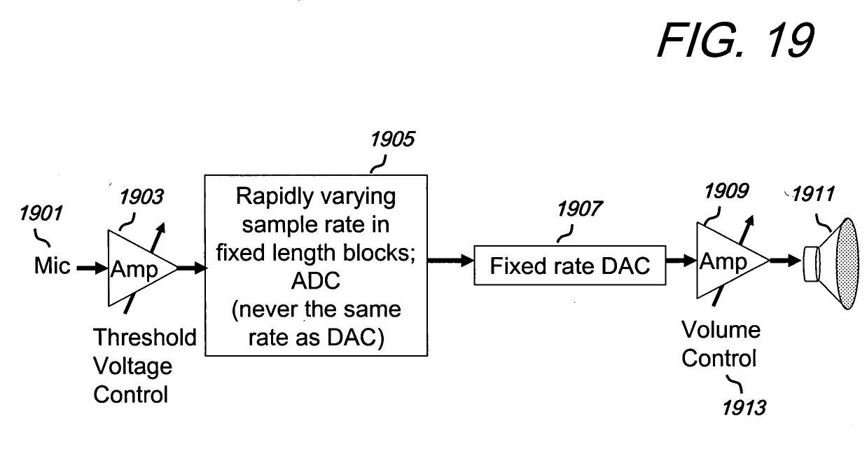

Referring to FIG. 19, another simplified block diagram suitable for practicing one or methods will be briefly described. In FIG. 19 a microphone 1901 is coupled to a microphone amplifier 1903 that includes a threshold adjustment 1905. The output of amplifier 1903 is coupled to variable rate sampler 1905, which rapidly varies the sampling rate for the signal from the amplifier. The sample rate remains fixed for specific blocks of time (but may change 5-100 times a second or the like) while not using a rate equal to a known fixed rate of the digital to analog converter 1907. The combination of the variable rate sampler 1905 or analog to digital converter and the fixed rate digital to analog converter 1907 generate the masking signal. These blocks with varying sample rates are converted in the digital to analog converter 1907 to an analog masking signal that is coupled to the amplifier 1909 and used to drive a speaker 1911 to provide a masking transmission. The amplifier 1909 can have an adjustable gain provided by volume control 1913. To reduce power consumed and possibly annoyance generated by this apparatus, the microphone signal can be sensed to effectively turn off the masking when the microphone signal level drops sufficiently low, e.g., below the threshold or set threshold adjustment 1905. As described time-scaling of each segment can be realized with analog-to-digital converters and digital-to-analog converters operating at different rates. Finally, the masking signal amplitude/power can be adjusted with the volume control 1913 coupled to the variable gain amplifier 1909 prior to applying the masking signal to the speaker 1911.

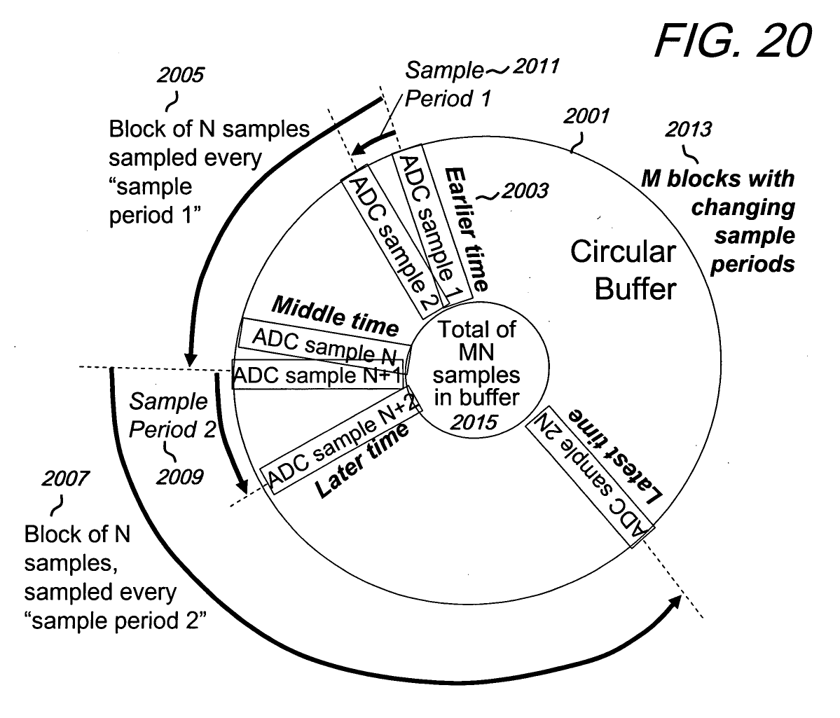

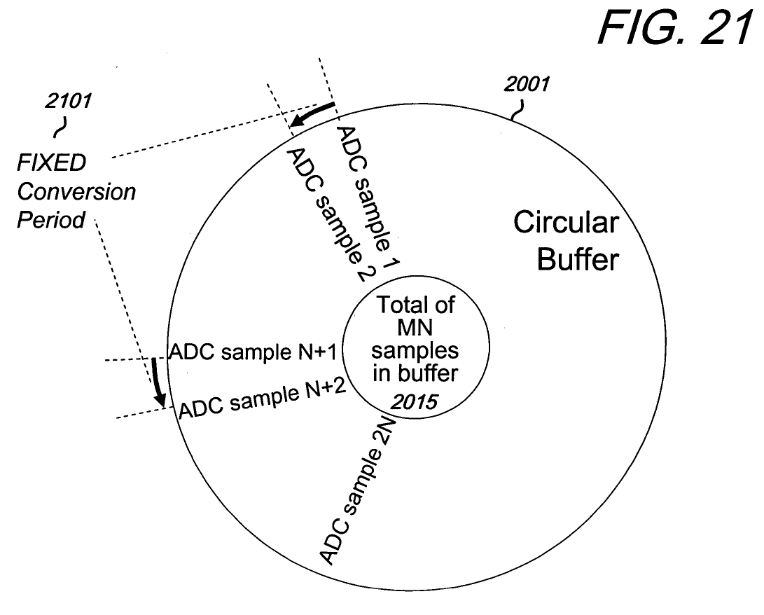

Referring to FIG. 20, a representative diagram is provided that shows a circular buffer arrangement for implementing the segmented and varying time-scaling techniques for providing, generating, or developing a masking signal. This diagram conceptually facilitates an appreciation for the operation of embodiments including variable rate samplers similar to FIG. 19. The circle 2001 represents a buffer or memory where the speech is recorded. The rectangular blocks around the circle (labeled, for example, ADC sample 1, etc.) represent samples (analog or digital) at instances in time. Time is assumed to be increasing in a counter-clockwise direction.

At an “earlier time” 2003, a block or segment of N speech samples 2005 are being taken; each sample being represented by an “ADC sample” rectangular block. After that segment/block of samples has been recorded or taken, the next block/segment of N samples 2007 is recorded, but now the recording rate (inverse of sample period 2 2009) is different than the sampling rate (inverse of sample period 1 2011) for the first segment/block. The sample period shown in the drawing is longer for the second segment/block, corresponding to a time-dilation or pitch decrease. As recordings are taken, they are simultaneously being played; thus, only a small memory/buffer (e.g., with M blocks 2013, MN samples 2015) is required and overwriting is acceptable after only a short period of time. No synchronization is required and the relative offset of the masking signal with respect to the speech signal can keep changing, allowing for any synchronization requirement to be relaxed.

Referring to FIG. 21, a representative diagram of an output circular buffer arrangement for providing a masking signal in accordance with FIG. 19 is shown. This diagram conceptually facilitates an appreciation for the operation of embodiments including, for example, fixed rate digital to analog converter used in conjunction with the variable rate sampler arrangement such as described with reference to FIG. 20. The circle 2001 represents a buffer or memory that may be of fixed size where the speech is recorded advantageously with a variable rate sampler as in FIG. 20. The rectangular blocks around the circle (labeled, for example, ADC sample 1, etc.) represent samples (analog or digital) which were recorded at various instances in time. Time is assumed to be increasing in a counter-clockwise direction. After the recording is made with variable sampling rates it can be played (e.g., converted in a digital to analog converter) at a constant, single, fixed rate 2101. Thus, the time-varying time-scaling of the original speech signal is achieved and the masking signal or core thereof is generated. Alternatively, the analog-to-digital conversion (recording) rate could be fixed and then the digital-to-analog (playing) rate could be rapidly varying. Also, both could be varying. One complete sweep or cycle through the circular buffer (MN samples 2015) should on average take the same total time as the total recording time. If the times are equal a buffer of MN samples is sufficient in size. If the recording time differs from the playback time the buffer would need to be slightly larger than MN samples to avoid overwriting any recorded samples.

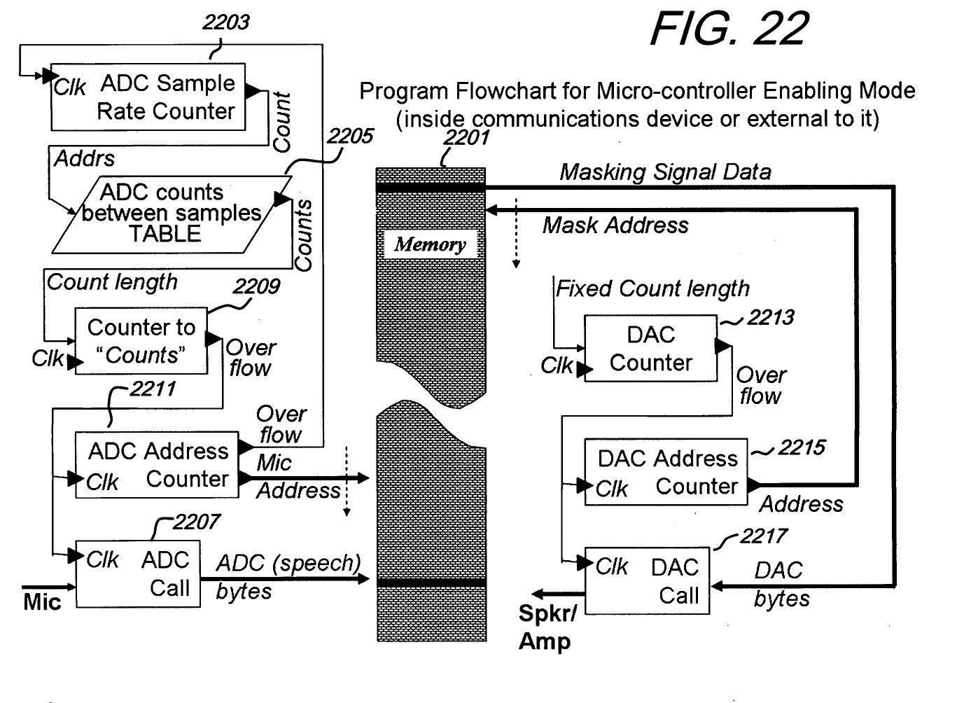

Referring to FIG. 22, a flow diagram and corresponding structure for a method of providing a masking signal is shown. The method may be implemented with software and a programmable processor or in hardware if preferred. A recording media, buffer or memory 2201 is required, as shown, to realize the time-scaling operation pursuant to providing a masking signal. A speech signal acquisition process will be described. The timing for the time-varying time-scaling is controlled through a series of counters. The counter 2203 in the upper left has an initial value (used as an incrementing address); where its initial starting count or value is arbitrary. This count is used to address an “ADC Counts Between Samples Table” 2205. This table includes a set of counts that correspond to the recording/sampling rate of a speech recorder/ADC (analog to digital converter) 2207 that is coupled to a microphone signal. This is the starting count for the next counter 2209 that times the recording/sampling process. When this counter overflows an indicator changes. This indicator is used to trigger the recording/sampling operation. Additionally, this indicator change is used to clock or increment the “ADC Address Counter” 2211. The ADC Address Counter count is the address pointer for the current recording/sample. The recording/sample is placed into memory at the corresponding memory address.

The mask generation process executes simultaneously with the speech signal acquisition process just described. The mask generation process pulls recordings/samples out of memory at a specified, fixed rate. This mask generation process is initialized with the Fixed DAC Count Length count in the DAC (digital to analog converter) counter 2213. Upon overflow of that counter it re-initializes to a count of the Fixed DAC Count Length count. The overflow also causes an indicator to change. This indicator change is utilized to clock or increment the DAC Address Counter 2215 and to trigger the DAC Call process 2217. The recording/sample at the DAC Address is accessed and passed to the DAC Call Process to convert the recording/sample into a signal for the speaker to transmit as the masking signal. Appropriate amplification can also be applied.

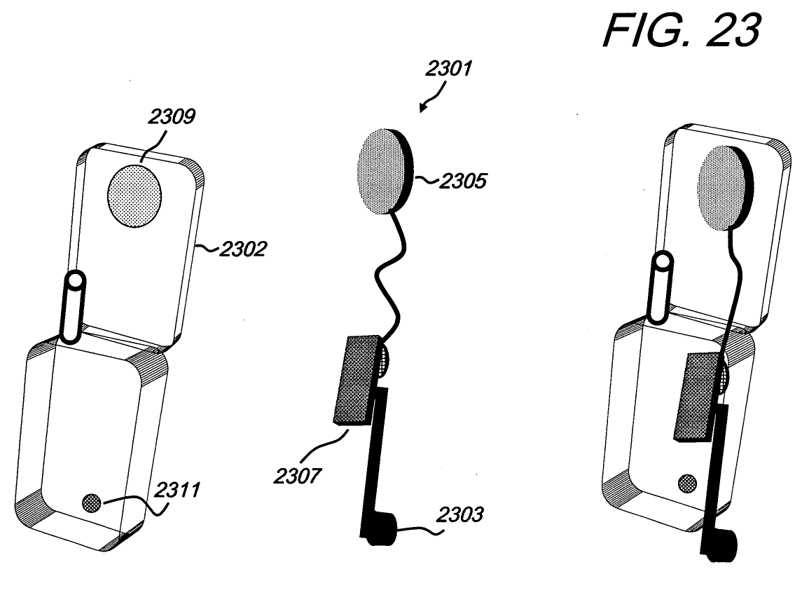

FIG. 23 illustrates an exemplary embodiment of a masking unit 2301 that may be associated with a communication device 2302. The masking unit provides personalized voice privacy by generating a masking signal or transmission that adaptively corresponds (i.e. similar energy distribution and normally greater volume) to a speech signal. The masking unit or apparatus 2301 includes a transducer or speaker 2305, masking signal generator 2307 (for example, one of the various embodiments discussed above) and a microphone 2303, where the microphone and thus signal corresponding to a voice signal from a user is coupled to the generator 2307 and the masking signal from the generator is coupled to the speaker 2305. The communication device will typically include a speaker 2309 or earpiece and microphone 2311 arranged to interface with the user. The speaker 2305 will be arranged to face away from the user while the microphone 2303 is arranged to face the user.

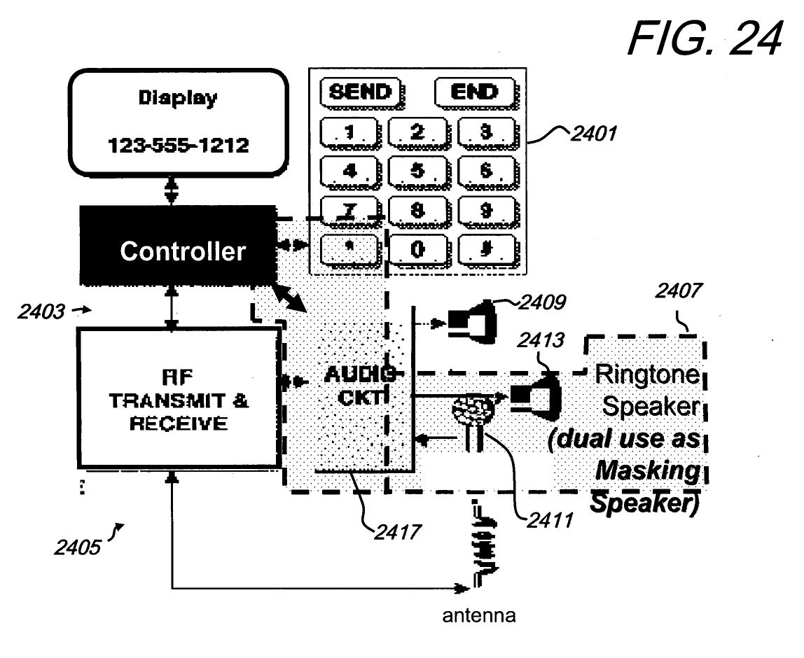

Referring to FIG. 24, an exemplary communication device including integrated voice masking of a speech signal will be described. The communication device is arranged and constructed for masking a speech signal originating from a user of the communication device, thereby providing the user with voice privacy that is personalized and available wherever the user and communication device may be located. The communication device includes a user interface 2401 configured to provide an interface between the communication device and the user and a controller 2403 coupled to the user interface and configured to facilitate the interface with the user and general control of the communication device. Further included is a communication interface 2405 (e.g., a radio transceiver for wireless devices or other appropriate transceiver for wired devices) that is coupled to and controlled by the controller and configured to send a signal corresponding to, i.e. modulated by, the speech signal to a remote party. Additionally included is a speech masking function 2407 configured to provide a masking transmission that adaptively corresponds to the speech signal, where the masking transmission originates from a location proximate to the user. The communication device and constituent elements or functions, other than the speech masking function is generally known, where the known elements or functions can take many forms depending on particular characteristics and capabilities of the device. The communication device can, for example, comprises at least one of a telephone, a packet data telephone, a wireless extension handset, a cellular handset, or a two way radio.

The user interface includes transducers, such as a speaker 2409, a microphone 2411, and an additional speaker 2413 that may, as shown be a ringtone speaker or speaker phone speaker if available. The additional speaker is physically arranged and directed away from the microphone and user (in normal use) and will be proximate to the microphone and thus user for normal communication devices. The speech masking function 2407 can be arranged and configured or functions in accordance with, for example, at least one of the embodiments discussed and described above. Advantageously, the speech masking function can be controlled (e.g., volume level and on/off) by normal user controls (part of keypad 2401).

The speech masking function can further use the microphone to sense the speech signal, a portion of the audio circuitry 2417 (microphone amplifier, speaker amplifier, ADC & DAC, etc) and a small portion of controller 2403 processing and memory resources as a masking generator or function 2407 to generate a masking signal that is dependent on the speech signal, and the ringtone or speaker phone speaker if available, else additional speaker 2413 as a transducer to provide the masking transmission. Thus the speech masking function is arranged and configured to sense the speech signal, generate a masking signal that is dependent on the speech signal, and apply the masking signal to a transducer, e.g. speaker driven by the masking function, to provide the masking transmission. The speech masking function comprises a microphone 2411 for providing a signal corresponding to the speech signal and a masking generator 2407 for providing the masking signal to the transducer. Of course the speech masking function can be an auxiliary device (physically integrated with the communication device or merely associated as depicted by FIG. 23) for the communication device. It may be advantageous if the speech masking function is at least partially mechanically integrated with or associated with the wireless communication device (for example the microphone, etc.) or partially functionally integrated (e.g., audio and controller resources) with the communications device.

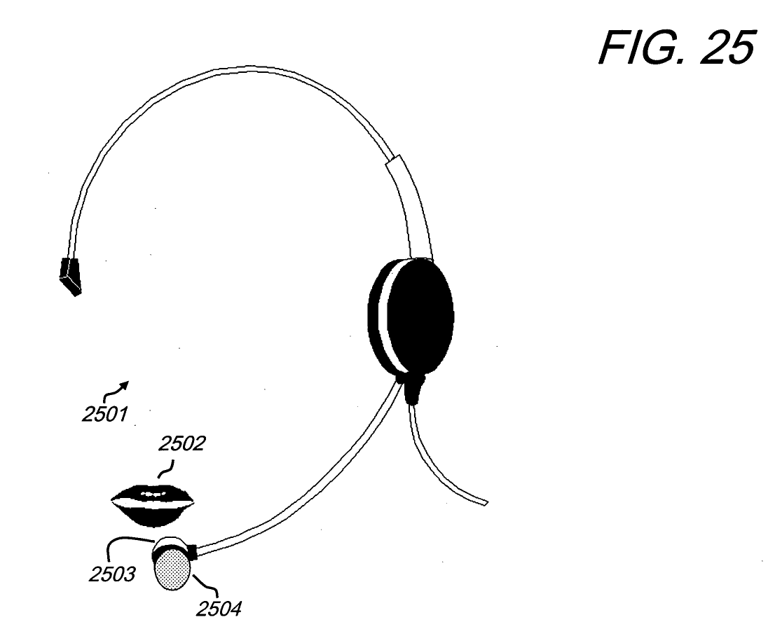

Referring to FIG. 25, an exemplary embodiment of a headset 2501 that is arranged and configured to provide voice masking. Note that the headset can be a wired headset as depicted or a wireless headset. The headset 2501 includes an earpiece arranged to interface with a user's ear as is known and a microphone 2503 that may be facing a person's mouth 2502 as shown. The headset further includes a speaker 2504 arranged and configured to direct a masking signal away from the microphone, i.e., person's mouth. Note that one or more of the embodiments for providing a masking signal discussed above may be fully integrated with the headset and thus a normal phone jack interface or wireless interface to other equipment may be used. Alternatively masking generation may be provided in total or part by other equipment with the headset largely comprising the transducer and associated connectivity. In either case a particularly elegant and given the physical arrangement of the microphone and speaker, particularly effective means for providing voice privacy can be realized.

The processes, apparatus, and systems, discussed above, and the inventive principles thereof are intended to and will alleviate problems caused by prior art signal masking or covering techniques. Using these principles of developing a masking signal that adaptively corresponds to the signal to be masked, e.g. speech signal, will simplify efficiently generating an effective masking signal while limiting annoyance to bystanders and thus facilitate utilization of communication devices by mobile professionals.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of adaptively masking signals, the method comprising:
providing a signal;
generating a masking signal that adaptively corresponds to the signal; and
inserting the masking signal into a channel corresponding to the signal at a location proximate to the source of the signal to facilitate masking the signal in the channel.

2. The method of claim 1 wherein the providing a signal further comprises providing a signal corresponding to an audible signal.

3. The method of claim 2 wherein the providing a signal corresponding to an audible signal further comprises providing a signal corresponding to a speech signal.

4. The method of claim 2 wherein the providing an audible signal further comprises determining whether the audible signal is active and when the audible signal is active inserting the masking signal into the channel.

5. The method of claim 1 wherein the generating a masking signal further comprises processing the signal to provide a masking signal that corresponds to an energy distribution of the signal.

6. The method of claim 5 wherein the processing the signal to provide a masking signal that corresponds to an energy distribution of the signal further comprises processing the signal to provide a masking signal that adaptively corresponds to the signal over time.

7. The method of claim 5 wherein the processing the signal to provide a masking signal that corresponds to an energy distribution of the signal further comprises processing the signal to provide a masking signal that adaptively corresponds to the signal over frequency.

8. The method of claim 5 wherein the processing the signal to provide a masking signal that corresponds to an energy distribution of the signal further comprises processing a noise signal to provide a masking signal that adaptively corresponds to the energy distribution of the signal.

9. The method of claim 5 wherein the processing the signal to provide a masking signal that adaptively corresponds to an energy distribution of the signal further comprises:
parsing the signal into a plurality of time segments of the signal;
transforming the plurality of time segments of the signal to provide a plurality of transformed time segments of the signal, each of the plurality of transformed time segments of the signal adaptively corresponding, respectively, to each of the plurality of time segments of the signal; and
combining the plurality of transformed time segments of the signal to provide the masking signal.

10. The method of claim 9 wherein the transforming the plurality of time segments of the signal further comprises for each of the plurality of time segments of the signal one or more transformations, the transformations selected from temporally reversing, frequency shifting, squaring, amplitude compressing, delaying, copying, clipping, and changing the amplitude of the time segment of the signal.

11. The method of claim 10 wherein a first and a second of the plurality of time segments of the signal are transformed using one or more of a different combination and a different sequence of the one or more transformations.

12. The method of claim 5 wherein the processing the signal to provide a masking signal that corresponds to an energy distribution of the signal further comprises:
recording the signal at one or more recording rates to provide a recorded signal; and
providing the masking signal by playing the recorded signal at a rate different from the one or more recording rates.

13. The method of claim 5 wherein the processing the signal to provide a masking signal that adaptively corresponds to an energy distribution of the signal further comprises:
recording the signal at a recording rate to provide a recorded signal, the recording rate changing across time; and
providing the masking signal by playing the recorded signal at a rate different from the recording rate.

14. The method of claim 5 wherein the processing the signal to provide a masking signal that adaptively corresponds to an energy distribution of the signal further comprises:
sampling the signal at one or more sampling rates to provide a sampled signal;
providing the masking signal by converting the sampled signal at a rate different from the one or more sampling rates.

15. The method of claim 5 wherein the processing the signal to provide a masking signal that adaptively corresponds to an energy distribution of the signal further comprises:
sampling the signal at a sampling rate where the sampling rate changes across time to provide a sampled signal;
providing the masking signal by converting the sampled signal at a rate different from the sampled rate.

16. The method of claim 1 wherein the providing a signal further comprises providing, from a microphone, a signal corresponding to a speech signal and the inserting the masking signal into a channel corresponding to the signal further comprises coupling the masking signal to a speaker that is proximate to the microphone to generate an output audible signal that adaptively masks the speech signal.

17. The method of claim 16 wherein the coupling the masking signal to a speaker further comprises varying the amplitude of the masking signal that is coupled to the speaker.

18. The method of claim 16 further comprising filtering the signal to remove portions of the signal corresponding to the audible signal.

19. The method of claim 1 implemented in conjunction with a communication device.

20. The method of claim 1 wherein:
the providing the signal further comprises providing a signal generated by a microphone responsive to an audible signal;
the generating the masking signal further comprises generating a masking signal that corresponds to an energy distribution of the signal generated by the microphone; and
the inserting the masking signal into the channel further comprises coupling the masking signal that corresponds to an energy distribution of the signal generated by the microphone to a transducer that is proximate to the microphone to provide an audible masking signal.

21. An apparatus arranged and constructed for masking speech signals, the apparatus comprising:
an input section configured to provide a signal corresponding to a speech signal;
a masking generator configured to generate a masking signal adaptively corresponding to the signal; and
a transducer configured to provide, proximate to a source of the speech signal, an audible masking transmission corresponding to the masking signal, wherein the audible masking transmission adaptively masks the speech signal.

22. The apparatus of claim 21 further comprising a detector coupled to the signal and configured to determine whether the signal is active and wherein, when the signal is determined to be active, the transducer provides the audible masking signal.

23. The apparatus of claim 21 further comprising an amplifier coupled to the masking signal and arranged to drive the transducer at two or more different output levels.

24. The apparatus of claim 21 wherein the input section further comprises a microphone to provide the signal corresponding to the speech signal and an adaptive filter that is coupled to and referenced to the masking signal, the adaptive filter configured to reduce a portion of the signal that corresponds to the masking signal.

25. The apparatus of claim 21 wherein the masking generator is further configured to generate a masking signal that adaptively corresponds to an energy distribution of the signal.

26. The apparatus of claim 21 wherein the masking generator is further configured to facilitate one or more transformations of portions of the signal, the transformations selected from temporally reversing, frequency shifting, squaring, amplitude compressing, delaying, copying, clipping, and changing the amplitude of the portions of the signal.

27. The apparatus of claim 26 wherein the masking generator is further configured to facilitate one or more of a different combination and a different sequence of the transformations on different portions of the signal.

28. The apparatus of claim 21 wherein the masking generator further comprises a signal processor configured to facilitate:
parsing the signal into a plurality of time segments of the signal;
transforming the plurality of time segments of the signal to provide a plurality of transformed time segments of the signal, each of the plurality of transformed time segments of the signal adaptively corresponding, respectively, to each of the plurality of time segments of the signal; and
combining the plurality of transformed time segments of the signal to provide the masking signal.

29. The apparatus of claim 21 wherein the masking generator further comprises:
an analog to digital converter for providing digital samples of the signal;
a buffer arranged to store a sequence of the samples of the signal;
a processor for controlling the buffer to retrieve the sequence of samples at a variable retrieval rate and transform at least a portion of the sequence of samples to provide a transformed sequence of samples; and
a digital to analog converter to convert the transformed sequence of samples to provide the masking signal.

30. The apparatus of claim 21 further comprising at least one microphone coupled to the input section and wherein the transducer is arranged to direct the audible masking transmission away from the microphone, the apparatus thereby configured to mask speech from at least one side of a conversation between a plurality of users.

31. The apparatus of claim 21 implemented in conjunction with a communication device comprising at least one of a portable device, a cellular phone, a public safety radio, a satellite radio, and a military radio.

32. The apparatus of claim 21 wherein the masking generator samples the signal at a sample rate to provide a sampled signal and converts the sampled signal at a rate that differs from the sample rate to generate the masking signal.

33. The apparatus of claim 21 wherein the masking generator samples the signal at a sample rate that varies over time to provide the sampled signal and converts the sampled signal at a rate that varies over time to generate the masking signal.

34. The apparatus of claim 21 comprising a user control for controlling the apparatus.

35. A communication device arranged and constructed for masking a speech signal originating from a user of the communication device, the communication device comprising:
a user interface configured to provide an interface between the communication device and the user;
a controller coupled the user interface and configured to facilitate the interface with the user and general control of the communication device;
a communication interface, coupled to and controlled by the controller, the communication interface configured to send a signal corresponding to the speech signal; and
a speech masking function configured to provide a masking transmission that adaptively corresponds to the speech signal, the masking transmission originating from a location proximate to the user.

36. The communication device of claim 35 wherein the speech masking function is arranged and configured to sense the speech signal, generate a masking signal that is dependent on the speech signal, and apply the masking signal to a transducer to provide the masking transmission.

37. The communication device of claim 36 wherein the speech masking function further comprises a microphone for providing a signal corresponding to the speech signal and a masking generator for providing the masking signal to the transducer.

38. The communication device of claim 35 wherein the speech masking function is an auxiliary device for the communication device.

39. The communication device of claim 38 wherein the speech masking function is at least in part mechanically associated with the wireless communication device.

40. The communication device of claim 39 wherein the communication device further comprises at least one of a telephone, a packet data telephone, a wireless extension handset, a cellular handset, and a two way radio.

41. The communication device of claim 35 wherein the speech masking function is functionally integrated with the communications device.

42. The communication device of claim 41 wherein the user interface includes a microphone and a speaker, the microphone providing a signal corresponding to the speech signal to the speech masking function and the speaker driven by the speech masking function to provide the masking transmission.

43. The communication device of claim 41 wherein the speech masking function is implemented at least in part in the controller.
